(19) United States
(12) Patent Application Publication
(10) Pub. No.: US 2010/0132681 A1
(43) Pub. Date: Jun. 3, 2010

(54) AIR-FUEL RATIO CONTROL APPARATUS AND AIR-FUEL RATIO CONTROL METHOD FOR INTERNAL COMBUSTION ENGINE

(76) Inventors: Shuntaro Okazaki, Sunto-gun, Shizuoka-ken (JP); Naoto Kato, Susono-shi, Shiozuoka-Ken (JP)

Correspondence Address: GIFFORD, KRASS, SPRINKLE,ANDERSON & CITKOWSKI, P.C, PO BOX 7021, TROY, MI, 48007-7021, US

(21) Appl. No.: 12/531,094

(22) PCT Filed: Jun. 20, 2008
(86) PCT No.: PCT/IB08/01618

§ 371 Date: Sep. 14, 2009

(30) Foreign Application Priority Data
Jun. 22, 2007 (JP) 2007-164587

(51) Int. Cl. F02D 41/00

(52) U.S. Cl. 123/703

(57) ABSTRACT

In an air-fuel ratio control apparatus for an internal combustion engine, a feedforward correction amount obtained in accordance with a deviation of a target air-fuel ratio from a stoichiometric air-fuel ratio and a feedback correction amount calculated on the basis of an output value of an air-fuel ratio sensor and subjected to a guard processing are added to a base fuel injection amount corresponding to the stoichiometric air-fuel ratio to decide a fuel injection amount. An upper limit (1) and a lower limit (1) of the feedback correction amount are set on the basis of an alcohol concentration and the feedforward correction amount.

### BACKGROUND OF THE INVENTION

1. Field of the Invention

The invention relates to an air-fuel ratio control apparatus and an air-fuel ratio control method that are applied to an internal combustion engine equipped with an air-fuel ratio sensor disposed in an exhaust passage to control the air-fuel ratio of a mixture supplied to a combustion chamber of the internal combustion engine (hereinafter referred to as “the air-fuel ratio”) on the basis of an output value of the air-fuel ratio sensor.

2. Description of the Related Art

An air-fuel ratio control apparatus for an internal combustion engine (which may be referred to hereinafter simply as “the engine”) equipped with a catalyst provided in an exhaust passage, an upstream-side air-fuel ratio sensor, such as a limiting current type oxygen concentration sensor, provided upstream of the catalyst in the exhaust passage, and a downstream-side air-fuel ratio sensor, such as an electromotive force type oxygen concentration sensor, provided downstream of the catalyst in the exhaust passage is described in, for example, Japanese Patent Application Publication No. 7-197837 (JP-A-7-197837). In this air-fuel ratio control apparatus, air-fuel ratio control is performed as follows.

An amount of air taken into a combustion chamber of the internal combustion engine in an intake stroke (an in-cylinder intake air amount) is decided through table search on the basis of an operational state of the engine (an output value of an airflow meter, an operational speed, and the like), and a value (a base fuel injection amount) obtained by dividing this in-cylinder intake air amount by a reference air-fuel ratio (=a stoichiometric air-fuel ratio) is calculated. A difference between an output value of the downstream-side air-fuel ratio sensor and a target value of this output value (a value corresponding to a target air-fuel ratio (=the stoichiometric air-fuel ratio)) is then subjected to a processing of proportion, integration, and differentiation (a PID processing) to calculate a downstream-side feedback correction amount. A difference (a difference corresponding thereto) between a value obtained by correcting an output value of the upstream-side air-fuel ratio sensor with this downstream-side feedback correction amount and a target value of this output value (a value corresponding to the target air-fuel ratio) is then subjected to a processing of proportion and integration (a PI processing) to calculate an upstream-side feedback correction amount. By adding the upstream-side feedback correction amount to the aforementioned base fuel injection amount (i.e., by making a feedback correction of the base fuel injection amount), a command fuel injection amount is calculated. A command to inject fuel in the command fuel injection amount is then issued to an injector. Thus, the air-fuel ratio is so feedback-controlled as to coincide with the target air-fuel ratio (=the stoichiometric air-fuel ratio).

In the aforementioned air-fuel ratio control, a difference between the base fuel injection amount decided using the aforementioned table search and a true value of “the value obtained by dividing the in-cylinder intake air amount by the reference air-fuel ratio” (an error of a table), a difference between an intake air flow rate measured by an airflow meter used to acquire the base fuel injection amount and an actual air flow rate (dispersion of the airflow meter), a difference between the command fuel injection amount issued to the injector as the command for injection and an amount of actually injected fuel (dispersion of the injector), and the like (which will be referred to hereinafter comprehensively as “an error of the base fuel injection amount”) inevitably arise.

Each of the aforementioned upstream-side feedback correction amount and the aforementioned downstream-side feedback correction amount (which will be referred to hereinafter simply as “the feedback correction amount” as well) includes a value of an integral term (an I term), namely, a value obtained by multiplying a difference integral value updated through sequential integration of the aforementioned difference by a feedback gain. Thus, even during the occurrence of “the error of the base fuel injection amount” as mentioned above, “the error of the base fuel injection amount” can be compensated for by the difference integral value (hence the value of the integral term) through the execution of the aforementioned feedback control. As a result, the air-fuel ratio can be made to coincide with/converge to the target air-fuel ratio.

In the case where an abnormality occurs in an air-fuel ratio control system during the execution of the aforementioned feedback control (e.g., when an abnormality occurs in the airflow meter, the injector, the air-fuel ratio sensors, or the like), the absolute value of the aforementioned difference continues to be held at a large value. As a result, the absolute value of the aforementioned difference integral value (hence the value of the integral term) gradually increases, and the absolute value of the feedback correction amount can thereby gradually increase. If the absolute value of the feedback correction amount becomes excessively large, there can be caused a problem in, for example, that the air-fuel ratio of the mixture, which is based on the command to inject fuel in the command fuel injection amount, deviates from a combustible range.

With the foregoing background, it is preferable to set a value that a total correction amount for the base fuel injection amount should not exceed (a first feedback guard value) and a value that the total correction amount for the base fuel injection amount should not drop below (a second feedback guard value) and perform a processing of limiting the feedback correction amount (or the difference integral value) to the first feedback guard value or the second feedback guard value (hereinafter referred to as “a guard processing”) when the feedback correction amount (or the difference integral value) exceeds the first feedback guard value or when the feedback correction amount drops below the second feedback guard value.

The execution of the guard processing with respect to the downstream-side feedback correction amount is described in, for example, Japanese Patent Application Publication No. 2005-36742 (JP-A-2005-36742). The execution of the guard processing with respect the difference integral value of the integral term included in the upstream-side feedback correction amount is described in Japanese Patent Application Publication No. 2004-60613 (JP-A-2004-60613).

The target air-fuel ratio may be set to an air-fuel ratio different from the reference air-fuel ratio (the stoichiometric air-fuel ratio) in accordance with an operational state of the engine (e.g., at the time of cold start or the like). In the case where the target air-fuel ratio is thus changed in accordance with the operational state of the engine, a feedforward correction amount is acquired in accordance with a deviation of the target air-fuel ratio from the reference air-fuel ratio, and the command fuel injection amount may be calculated by correcting the base fuel injection amount with the feedback correction amount and the feedforward correction amount. In other words, “a feedforward correction of the base fuel injection amount with the feedforward correction amount” (hereinafter referred to simply as “the feedforward correction” as well) can be made in addition to “the feedback correction of the base fuel injection amount with the feedback correction amount” as mentioned above (hereinafter referred to simply as “the feedback correction” as well).

In the case where “the feedforward correction” is thus made in addition to “the feedback correction”, it is contemplable to use a value equal to “the value that the total correction amount for the base fuel injection amount should not exceed” and a value equal to “the value that the total correction amount for the base fuel injection amount should not drop below” as the aforementioned first feedback guard value and the aforementioned second feedback guard value respectively, as in the aforementioned case where only “the feedback correction” is made.

In this case, the total correction amount for the base fuel injection amount based on the feedback correction amount and the feedforward correction amount can become larger than “the value that the total correction amount for the base fuel injection amount should not exceed” by the feedforward correction amount, and smaller than “the value that the total correction amount for the base fuel injection amount should not drop below” by the feedforward correction amount. That is, even when the feedback correction amount is subjected to the guard processing, the problem such as deviation of the air-fuel ratio from the combustible range or the like can be caused.

In addition, fuels containing alcohol components (e.g., gasoline+alcohol or only alcohol) have recently been used for vehicular internal combustion engines. Alcohol has a smaller average molecular weight than gasoline. Accordingly, the average molecular weight of gasoline fuel decreases as the concentration of alcohol components contained therein (hereinafter referred to simply as “the alcohol concentration”) increases.

In the case where the concentration of reductive components (i.e., unburned fuel) is constant in exhaust gas having an air-fuel ratio richer than the stoichiometric air-fuel ratio, the aforementioned limiting current type oxygen concentration sensor or the aforementioned electromotive force oxygen concentration sensor tends to generate an output that shifts toward a rich side as the average molecular weight of the reductive components decreases. This tendency is considered to be based on the fact that the reductive components is more likely to enter the interior of a sensor reaction portion (zirconia or the like) and a reaction in the sensor reaction portion is more likely to proceed as the average molecular weight of the reductive components decreases.

Due to the foregoing circumstances, in the case where a relationship between the output of the limiting current type oxygen concentration sensor or the electromotive force type oxygen concentration sensor and the air-fuel ratio obtained from the output (a detected air-fuel ratio) is prescribed in a manner corresponding to a case where the alcohol concentration=0%, the detected air-fuel ratio tends to shift more toward the rich side with respect to the actual air-fuel ratio as the alcohol concentration increases when the air-fuel ratio of exhaust gas is richer than the stoichiometric air-fuel ratio (see FIG. 2, which will be described later). Furthermore, in the case where the target air-fuel ratio is richer than the stoichiometric air-fuel ratio, the actual air-fuel ratio, which is so controlled as to coincide with the target air-fuel ratio, is likely to become richer than the stoichiometric air-fuel ratio.

This phenomenon means that the actual air-fuel ratio is adjusted to a value shifted toward a lean side with respect to a target thereof because the detected air-fuel ratio shifts toward the rich side with respect to the actual air-fuel ratio in the case where the alcohol concentration is high and the target air-fuel ratio is richer than the stoichiometric air-fuel ratio. Accordingly, in this case, even when, for example, the total correction amount for the base fuel injection amount has not dropped below “the value that the total correction amount for the base fuel injection amount should not drop below”, there can be caused a problem in, for example, that the air-fuel ratio deviates from the combustible range toward the lean side.

### SUMMARY OF THE INVENTION

The invention provides an air-fuel ratio control apparatus and an air-fuel ratio control method for an internal combustion engine that set guard values for a feedback correction amount to suitable values in consideration of an alcohol concentration in the case where “a feedforward correction” is made in addition to “a feedback correction” for a base fuel injection amount.

A first aspect of the invention relates to an air-fuel ratio control apparatus for an internal combustion engine. This air-fuel ratio control apparatus includes: an air-fuel ratio sensor that is provided in an exhaust passage of the internal combustion engine, and that outputs an air-fuel ratio of gas in the exhaust passage; an alcohol concentration sensor that detects an alcohol concentration as a concentration of alcohol components contained in fuel; a fuel injection device that injects fuel in accordance with a command to inject fuel in a command fuel injection amount; a base fuel injection amount acquisition unit that determines a base fuel injection amount on the basis of an amount of air taken into a combustion chamber of the internal combustion engine in an intake stroke and a reference air-fuel ratio; a target air-fuel ratio acquisition unit that determines a target air-fuel ratio of the internal combustion engine on the basis of an operational state of the internal combustion engine; a feedforward correction amount acquisition unit that determines a feedforward correction amount for correcting the base fuel injection amount on the basis of a deviation of the target air-fuel ratio from the reference air-fuel ratio; a feedback correction amount acquisition unit that determines a feedback correction amount for correcting the base fuel injection amount on the basis of an output value of the air-fuel ratio sensor; a guard processing execution unit that executes a guard processing for limiting the feedback correction amount to a first feedback guard value when the feedback correction amount exceeds the first feedback guard value and limiting the feedback correction amount to a second feedback guard value when the feedback correction amount drops below the second feedback guard value; a command fuel injection amount calculation unit that calculates the command fuel injection amount by correcting the base fuel injection amount on the basis of the feedforward correction amount and the feedback correction amount subjected to the guard processing; and an air-fuel ratio control unit that controls an air-fuel ratio of a mixture supplied to the combustion chamber such that the air-fuel ratio of the mixture coincides with the target air-fuel ratio by issuing to the fuel injection device a command to inject fuel in the command fuel injection amount. The guard processing performance unit sets the first feedback guard value and the second feedback guard value on the basis of the alcohol concentration and the feedforward correction amount.

In the air-fuel ratio control apparatus according to the invention, the base fuel injection amount acquisition unit determines a value (the base fuel injection amount) obtained by dividing an in-cylinder intake air amount by a reference air-fuel ratio (e.g., the stoichiometric air-fuel ratio), on the basis of the operational state of the internal combustion engine. It should be noted herein that the stoichiometric air-fuel ratio (i.e., the ratio of the amount of air to the amount of fuel that corresponds to a case where oxygen in air and fuel react with each other in just proportion) changes in accordance with the alcohol concentration. Therefore, the reference air-fuel ratio also changes in accordance with the alcohol concentration.

The target air-fuel ratio acquisition unit acquires the target air-fuel ratio, which changes in accordance with the operational state of the internal combustion engine (an operation amount of an accelerator, an operational speed, and the like), on the basis of the operational state. As described above, the reference air-fuel ratio changes in accordance with the alcohol concentration. Therefore, the target air-fuel ratio also changes in accordance with the alcohol concentration.

The feedforward correction amount acquisition unit determines the feedforward correction amount for correcting the base fuel injection amount, which corresponds to a deviation of the target air-fuel ratio from the reference air-fuel ratio. This feedforward correction amount may be a value added to (subtracted from) the base fuel injection amount or a value by which the base fuel injection amount is multiplied.

The feedback correction amount acquisition unit determines the feedback correction amount for correcting the base fuel injection amount on the basis of the output value of the air-fuel ratio sensor. In this case, the feedback correction amount may be, for example, a difference integral value itself that is updated through sequential integration of a value corresponding to a difference between a value based on the output value of the air-fuel ratio sensor and a value corresponding to the target air-fuel ratio, or a value obtained by subjecting “the value corresponding to the difference” as mentioned above to the PID processing or the like. “The value based on the output value of the air-fuel ratio sensor” as mentioned above is, for example, an output value itself of an upstream-side air-fuel ratio sensor, an output value itself of a downstream-side air-fuel ratio sensor, a value obtained by correcting the output value of the upstream-side air-fuel ratio sensor on the basis of the output value of the downstream-side air-fuel ratio sensor, or the like. “The value corresponding to the difference” as mentioned above is, for example, a difference between an output value of the air-fuel ratio sensor and a value corresponding to the target air-fuel ratio, a difference between an air-fuel ratio detected by the air-fuel ratio sensor and the target air-fuel ratio, or the like. This feedback correction amount may also be a value added to (subtracted from) the base fuel injection amount, or a value by which the base fuel injection amount is multiplied.

The guard processing execution unit executes the guard processing of limiting the feedback correction amount to the first feedback guard value, which corresponds to an increasing direction (hereinafter referred to also as “a gain direction”) of the command fuel injection amount, when the feedback correction amount exceeds the first feedback guard value, and limiting the feedback correction amount to the second feedback guard value, which corresponds to a decreasing direction (hereinafter referred to also as “a loss direction”), when the feedback correction amount drops below the second feedback guard value.

The command fuel injection amount calculation unit calculates the command fuel injection amount by correcting the base fuel injection amount on the basis of the feedforward correction amount and the feedback correction amount subjected to the guard processing. The air-fuel ratio control unit then issues to the fuel injection device the command to inject fuel in the command fuel injection amount. The air-fuel ratio is thereby so feedback-controlled as to coincide with the target air-fuel ratio. As described above, in the air-fuel ratio control apparatus according to the invention, “the feedforward correction” is made in addition to “the feedback correction”.

The guard processing execution unit sets the first feedback guard value and the second feedback guard value on the basis of the alcohol concentration and the feedforward correction amount.

According to the foregoing configuration, the first feedback guard value and the second feedback guard value can be decided in consideration of the feedforward correction amount (furthermore in consideration of “the total correction amount” for the base fuel injection amount based on the feedback correction amount and the feedforward correction amount) and in consideration of the alcohol concentration (i.e., in consideration of the actual air-fuel ratio being adjusted to a value shifted toward the lean side with respect to a target thereof in the case where the target air-fuel ratio is richer than the stoichiometric air-fuel ratio). Accordingly, the occurrence of a problem such as deviation of the air-fuel ratio from the combustible range or the like can be prevented regardless of the magnitudes of the feedforward correction amount and the alcohol concentration.

In the foregoing aspect of the invention, the guard processing execution unit may set a first total guard value as a value that “the total correction amount” should not exceed in “the gain direction” and a second total guard value as a value that “the total correction amount” should not drop below in “the loss direction” on the basis of the alcohol concentration in a case where the target air-fuel ratio is richer than the reference air-fuel ratio, set the first feedback guard value to a value equal to a feedback correction amount corresponding to a case where “the total correction amount” coincides with the first total guard value, and set the second feedback guard value to a value equal to a feedback correction amount corresponding to a case where “the total correction amount” coincides with the second total guard value.

According to the foregoing configuration, the first feedback guard value and the second feedback guard value are set to values obtained by removing the value of the feedforward correction amount from the first total guard value and the second total guard value respectively. Accordingly, the occurrence of a problem such as deviation of the air-fuel ratio from the combustible range or the like can be prevented while setting the first feedback guard value and the second feedback guard value as large as possible (i.e., while holding the difference between the first feedback guard value and the second feedback guard value (a guard width) as large as possible).

In addition, the first total guard value and the second total guard value are so set as to change in accordance with the alcohol concentration when the target air-fuel ratio is richer than the reference air-fuel ratio. Accordingly, the first total guard value and the second total guard value can be set in consideration of the actual air-fuel ratio being adjusted to a value shifted toward the lean side with respect to the target thereof as a result of a shift of the detected air-fuel ratio toward the rich side with respect to the actual air-fuel ratio (hereinafter referred to simply as “the shift of the detected air-fuel ratio toward the rich side”). As a result, the occurrence of a problem such as deviation of the air-fuel ratio from the combustible range or the like can further be prevented when the target air-fuel ratio is richer than the reference air-fuel ratio.

More specifically, the first total guard value may be set constant, namely, to a first predetermined value when the target air-fuel ratio is leaner than the reference air-fuel ratio, and may be increased from the first predetermined value as the alcohol concentration increases or the target air-fuel ratio shifts away from the reference air-fuel ratio toward the rich side when the target air-fuel ratio is richer than the reference air-fuel ratio. The second total guard value may be set constant, namely, to a second predetermined value when the target air-fuel ratio is leaner than the reference air-fuel ratio, and may be increased from the second predetermined value as the alcohol concentration increases or the target air-fuel ratio shifts away from the reference air-fuel ratio toward the rich side when the target air-fuel ratio is richer than the reference air-fuel ratio.

In the case where the actual air-fuel ratio is adjusted to a value shifted toward the lean side with respect to the target thereof as a result of “the shift of the detected air-fuel ratio toward the rich side”, even when “the total correction amount” as mentioned above is equal to the aforementioned first predetermined value, the actual air-fuel ratio is still shifted toward the lean side with respect to a limit of the combustible range on the rich side by a value corresponding to “the shift of the detected air-fuel ratio toward the rich side”. That is, there is a room for setting the first total guard value larger than the first predetermined value by the value corresponding to “the shift of the detected air-fuel ratio toward the rich side” (there is a room for increasing the aforementioned guard width in the gain direction).

On the other hand, when “the total correction amount” as mentioned above is equal to the aforementioned second predetermined value, the actual air-fuel ratio is shifted toward the lean side with respect to a limit of the combustible range on the lean side by a value corresponding to “the shift of the detected air-fuel ratio toward the rich side” (i.e., has exceeded the limit on the lean side). That is, there is a need to set the second total guard value larger than the second predetermined value by the value corresponding to “the shift of the detected air-fuel ratio toward the rich side” (there is a need to reduce the aforementioned guard width in the loss direction).

In addition, the magnitude of “the shift of the detected air-fuel ratio toward the rich side” increases as the alcohol concentration increases and the target air-fuel ratio (hence the actual air-fuel ratio) shifts away from the reference air-fuel ratio toward the rich side. The setting of the first total guard value and the second total guard value to larger values means the setting of the first feedback guard value and the second feedback guard value to larger values.

A second aspect of the invention relates to an air-fuel ratio control method for an internal combustion engine including: an air-fuel ratio sensor that is provided in an exhaust passage of the internal combustion engine, and that outputs an air-fuel ratio of gas in the exhaust passage; an alcohol concentration sensor that detects an alcohol concentration as a concentration of alcohol components contained in fuel; and a fuel injection device that injects fuel in accordance with a command to inject fuel in a command fuel injection amount. This air-fuel ratio control method includes: determining a base fuel injection amount on the basis of an amount of air taken into a combustion chamber of the internal combustion engine in an intake stroke and a reference air-fuel ratio; determining a target air-fuel ratio of the internal combustion engine on the basis of an operational state of the internal combustion engine; determining a feedforward correction amount for correcting the base fuel injection amount on the basis of a deviation of the target air-fuel ratio from the reference air-fuel ratio; determining a feedback correction amount for correcting the base fuel injection amount on the basis of an output value of the air-fuel ratio sensor; executing a guard processing for limiting the feedback correction amount to a first feedback guard value when the feedback correction amount exceeds the first feedback guard value and limiting the feedback correction amount to a second feedback guard value when the feedback correction amount drops below the second feedback guard value; calculating the command fuel injection amount by correcting the base fuel injection amount on the basis of the feedforward correction amount and the feedback correction amount subjected to the guard processing; and controlling an air-fuel ratio of a mixture supplied to the combustion chamber such that the air-fuel ratio of the mixture coincides with the target air-fuel ratio by issuing to the fuel injection device a command to inject fuel in the command fuel injection amount. The first feedback guard value and the second feedback guard value are set on the basis of the alcohol concentration and the feedforward correction amount.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic diagram of an air-fuel ratio control apparatus for an internal combustion engine according to the first embodiment of the invention;

FIG. 2 is a graph showing a relationship between output voltage of an upstream-side air-fuel ratio sensor shown in FIG. 1 and air-fuel ratio;

FIG. 3 is a graph showing a relationship between output voltage of a downstream-side air-fuel ratio sensor shown in FIG. 1 and air-fuel ratio;

FIG. 4 is a graph showing a relationship between alcohol concentration and a coefficient K;

FIG. 5 is a functional block diagram during the performance of air-fuel ratio control by the air-fuel ratio control apparatus shown in FIG. 1;

FIG. 6 is a diagram for explaining a method of setting an upper-limit guard value and a lower-limit guard value of a feedback correction amount by the air-fuel ratio control apparatus shown in FIG. 1;

FIG. 7 is a flowchart showing a routine executed by the air-fuel ratio control apparatus shown in FIG. 1 to calculate a feedforward correction amount and a fuel injection amount and issue a command for injection;

FIG. 8 is a flowchart showing a routine executed by the air-fuel ratio control apparatus shown in FIG. 1 to calculate a feedback correction amount;

FIG. 9 is a flowchart showing a routine executed by the air-fuel ratio control apparatus shown in FIG. 1 to calculate a sub-feedback correction amount;

FIG. 10 is a functional block diagram during the execution of air-fuel ratio control by an air-fuel ratio control apparatus for an internal combustion engine according to the second embodiment of the invention;

FIG. 11 is a flowchart showing a routine executed by the air-fuel ratio control apparatus for the internal combustion engine according to the second embodiment of the invention to calculate a feedforward correction rate and a fuel injection amount and issue a command for injection; and

FIG. 12 is a flowchart showing a routine executed by the air-fuel ratio control apparatus for the internal combustion engine according to the second embodiment of the invention to calculate a feedback correction rate.

### DETAILED DESCRIPTION OF THE EMBODIMENTS

An air-fuel ratio control apparatus for an internal combustion engine according to the first embodiment of the invention and an air-fuel ratio control apparatus for an internal combustion engine according to the second embodiment of the invention will be described hereinafter with reference to the drawings.

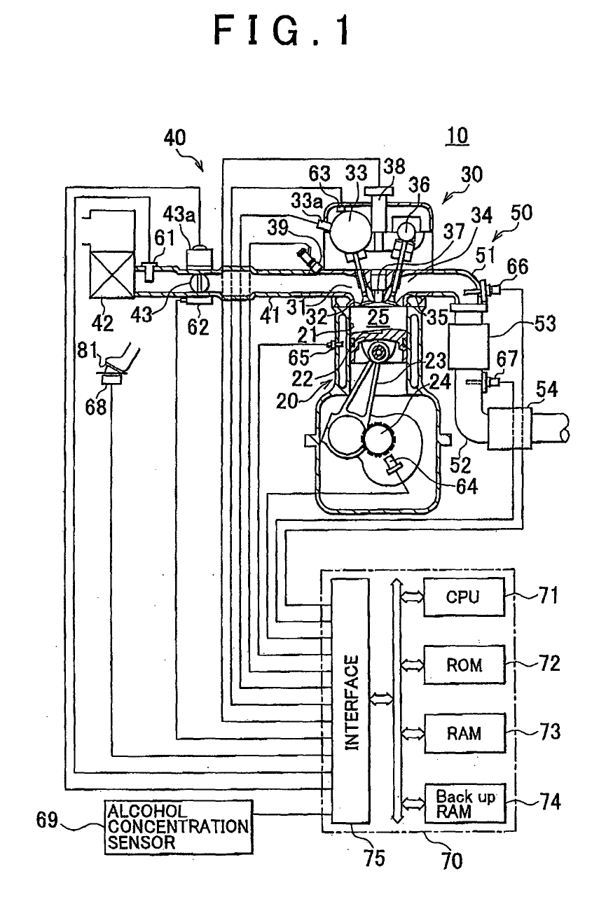

FIG. 1 shows a schematic configuration of a system obtained by applying the air-fuel ratio control apparatus according to the first embodiment of the invention to a spark ignition type multi-cylinder (four-cylinder) internal combustion engine 10. This internal combustion engine 10 includes a cylinder block portion 20 including a cylinder block, a cylinder block lower case, and an oil pan, a cylinder head portion 30 fixed on the cylinder block portion 20, an intake system 40 for supplying a gasoline mixture to the cylinder block portion 20, and an exhaust system 50 for discharging exhaust gas from the cylinder block portion 20 to the outside. The internal combustion engine 10 can use only gasoline (alcohol concentration=0%), gasoline containing alcohol components, or only alcohol (alcohol concentration=100%) as fuel.

The cylinder block portion 20 includes a cylinder 21, a piston 22, a connecting rod 23, and a crankshaft 24. The piston 22 moves in the cylinder 21 in a reciprocating manner, and reciprocating movements of the piston 22 are transmitted to the crankshaft 24 via the connecting rod 23. The crankshaft 24 thereby rotates. Together with the cylinder head portion 30, the cylinder 21 and a head of the piston 22 form a combustion chamber 25.

The cylinder head portion 30 is equipped with an intake port 31, an intake valve 32, a variable intake timing device 33, an actuator 33a for the variable intake timing device 33, an exhaust port 34, an exhaust valve 35, an exhaust camshaft 36, an ignition plug 37, an igniter 38, and an injector (a fuel injection device) 39. The intake port 31 communicates with the combustion chamber 25. The intake valve 32 opens/closes the intake port 31. The variable intake timing device 33 includes an intake camshaft for driving the intake valve 32 and continuously changes the phase angle of the intake camshaft. The exhaust port 34 communicates with the combustion chamber 25. The exhaust valve 35 opens/closes the exhaust port 34. The exhaust camshaft 36 drives the exhaust valve 35. The igniter 38 includes an ignition coil for generating a high voltage applied to the ignition plug 37. The injector (the fuel injection device) 39 injects fuel into the intake port 31.

The intake system 40 is equipped with an intake pipe 41 including an intake manifold communicating with the intake port 31 to form an intake passage together with the intake port 31, an air filter 42 provided at an end of the intake pipe 41, a throttle valve 43 provided in the intake pipe 41 to make the opening cross-sectional area of the intake passage variable, and a throttle valve actuator 43a constructed as a DC motor constituting a throttle valve driving device.

The exhaust system 50 is equipped with an exhaust manifold 51 communicating with the exhaust port 34, an exhaust pipe 52 connected to an exhaust manifold 51 (in reality, an aggregate portion where respective exhaust manifolds 51 communicating with respective exhaust ports 34 aggregate), an upstream-side three-way catalyst 53 (an upstream-side catalytic converter that will be referred to hereinafter as “the first catalyst 53”) disposed (interposed) in the exhaust pipe 52, and a downstream-side three-way catalyst 54 (hereinafter referred to as “the second catalyst 54”) disposed (interposed) downstream of the first catalyst 53 in the exhaust pipe 52. The exhaust port 34, the exhaust manifold 51, and the exhaust pipe 52 constitute an exhaust passage.

On the other hand, this system is equipped with a hot wire type airflow meter 61, a throttle position sensor 62, a cam position sensor 63, a crank position sensor 64, a coolant temperature sensor 65, an air-fuel ratio sensor 66 (hereinafter referred to as “the upstream-side air-fuel ratio sensor 66”) disposed upstream of the first catalyst 53 in the exhaust passage (in this embodiment of the invention, an aggregate portion where the aforementioned respective exhaust manifolds 51 aggregate), an air-fuel ratio sensor 67 (hereinafter referred to as “the downstream-side air-fuel ratio sensor 67”) disposed downstream of the first catalyst 53 and upstream of the second catalyst 54 in the exhaust passage, an accelerator opening degree sensor 68, and an alcohol concentration sensor 69.

The hot wire type airflow meter 61 detects a mass flow rate of intake air flowing in the intake pipe 41 per unit time, and outputs a signal indicating a mass flow rate Ga. The throttle position sensor 62 detects an opening degree of the throttle valve 43, and outputs a signal indicating a throttle valve opening degree TA. The cam position sensor 63 outputs a signal (a G2 signal) having one pulse every time the intake camshaft rotates by 90° (i.e., every time the crankshaft 24 rotates by 180°). The crank position sensor 64 outputs a signal having a narrow pulse every time the crankshaft 24 rotates by 10° and having a wide pulse every time the crankshaft 24 rotates by 360°. This signal indicates an operational speed NE of the internal combustion engine 10. The coolant temperature sensor 65 detects a temperature of coolant in the internal combustion engine 10, and outputs a signal indicating a coolant temperature THW.

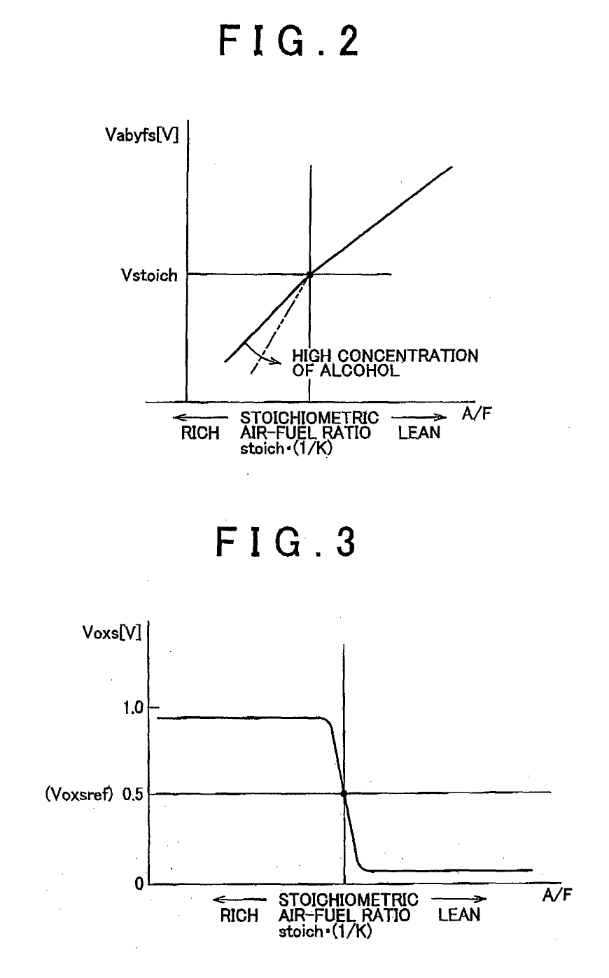

The upstream-side air-fuel ratio sensor 66 is a limiting current type oxygen concentration sensor, and outputs an output value Vabyfs as a voltage corresponding to a current output in accordance with an air-fuel ratio A/F as indicated by a solid line in FIG. 2. The output value Vabyfs of the upstream-side air-fuel ratio sensor 66 is equal to an upstream-side target value Vstoich when the air-fuel ratio is equal to the stoichiometric air-fuel ratio (a reference air-fuel ratio).

The downstream-side air-fuel ratio sensor 67 is an electromotive force type (concentration cell type) oxygen concentration sensor, and outputs an output value Voxs as a voltage changing suddenly in the neighborhood of the stoichiometric air-fuel ratio as shown in FIG. 3. To be more specific, the downstream-side air-fuel ratio sensor 67 outputs a voltage of about 0.1 (V) when the air-fuel ratio is leaner than the stoichiometric air-fuel ratio, a voltage of about 0.9 (V) when the air-fuel ratio is richer than the stoichiometric air-fuel ratio, and a voltage of 0.5 (V) when the air-fuel ratio is equal to the stoichiometric air-fuel ratio. The accelerator opening degree sensor 68 detects an operation amount of an accelerator pedal 81 operated by a driver, and outputs a signal indicating an operation amount Accp of the accelerator pedal 81.

The alcohol concentration sensor 69 detects a concentration of alcohol components (ethanol and the like) contained in fuel accumulated in a fuel tank (not shown) (i.e., the aforementioned alcohol concentration, a mass concentration in this embodiment of the invention), and outputs a signal indicating an alcohol concentration R (0≦R≦100 (%)).

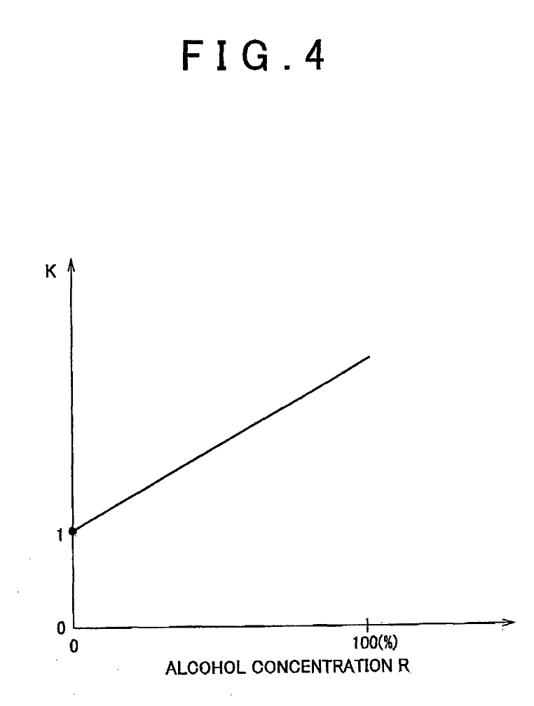

In this embodiment of the invention, a coefficient K (1≦K) set as shown in FIG. 4 is used. This coefficient K is set to “1” when the alcohol concentration R is equal to 0%, and is so set as to increase from “1” as the alcohol concentration R increases. Given that the stoichiometric air-fuel ratio at the time when the alcohol concentration R=0% is denoted by stoich (e.g., 14.6), the stoichiometric air-fuel ratio at the time when the alcohol concentration R≧0% can be expressed as “stoich·(1/K)”.

An electronic control unit 70 is a microcomputer composed of a CPU 71, a ROM 72, a RAM 73, a backup RAM 74, and an interface 75 including AD converters. Routines (programs) executed by the CPU 71, tables (look-up tables and maps), constants, and the like are stored in advance in the ROM 72. The interface 75 is connected to the aforementioned sensors 61 to 69, supplies signals from the sensors 61 to 69 to the CPU 71, and delivers drive signals to the actuator 33a for the variable intake timing device 33, the igniter 38, the injector 39, and the throttle valve actuator 43a. The CPU 71, the ROM 72, the RAM 73, the backup RAM 74, and the interface 75 are connected to a bus that is common thereto.

Next, the outline of air-fuel ratio control executed by the air-fuel ratio control apparatus configured as described above (hereinafter referred to as “this apparatus”) will be described.

The air-fuel ratio control apparatus according to this embodiment of the invention controls the air-fuel ratio in accordance with the output value Vabyfs of the upstream-side air-fuel ratio sensor 66 (i.e., the air-fuel ratio upstream of the first catalyst 53) and the output value Voxs of the downstream-side air-fuel ratio sensor 67 (i.e., the air-fuel ratio downstream of the first catalyst 53) such that the output value of the downstream-side air-fuel ratio sensor 67 becomes equal to a downstream-side target value Voxsref (e.g., 0.5 (V), see FIG. 3) corresponding to the stoichiometric air-fuel ratio (the reference air-fuel ratio).

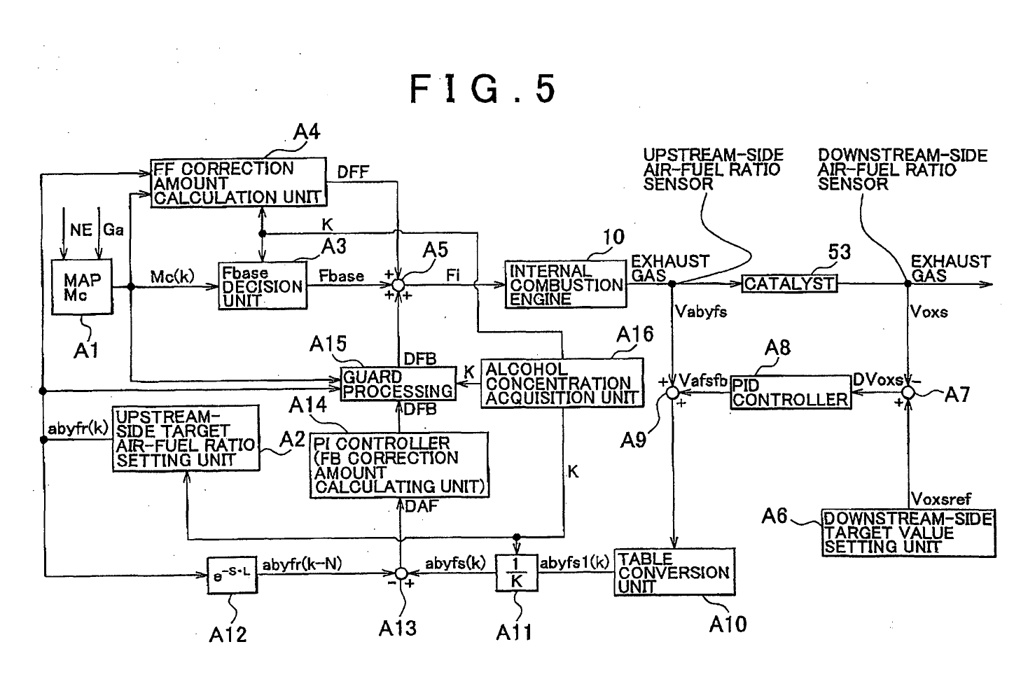

To be more specific, the air-fuel ratio control apparatus according to this embodiment of the invention is configured with respective functional blocks A1 to A16 as is apparent from a functional block diagram shown in FIG. 5. The respective functional blocks will be described hereinafter with reference to FIG. 5. In the following description, “feedback” and “feedforward” may be referred to as “FB” and “FF” respectively.

An in-cylinder intake air amount calculation unit A1 calculates an in-cylinder intake air amount Mc(k) as a current intake air amount of a cylinder undergoing an intake stroke on the basis of the intake air flow rate Ga detected by the airflow meter 61, the operational speed NE obtained on the basis of the output of the crank position sensor 64, and a table MapMc stored in the ROM 72. It should be noted herein that a value accompanied by a suffix (k) relates to a current intake stroke (the same will hold true hereinafter for the other physical quantities). The in-cylinder intake air amount Mc(k) is stored into the RAM 73 while being associated with an intake stroke of each cylinder. For example, an in-cylinder intake air amount Mc(k−1) represents an intake air amount in the last intake stroke.

An upstream-side target air-fuel ratio setting unit A2 decides an upstream-side target air-fuel ratio abyfr(k) (“the target air-fuel ratio” as mentioned above) on the basis of the operational speed NE as the operational state of the internal combustion engine 10, the accelerator pedal operation amount Accp, and the coefficient K. In principle, this upstream-side target air-fuel ratio abyfr(k) is set to the stoichiometric air-fuel ratio (=stoich·(1/K)). On the other hand, the upstream-side target air-fuel ratio abyfr(k) is also set to an air-fuel ratio other than the stoichiometric air-fuel ratio when the operational speed NE, the accelerator pedal operation amount Accp, or the like assumes a certain value. The upstream-side target air-fuel ratio abyfr(k) is stored into the RAM 73 while being associated with an intake stroke of each cylinder. This upstream-side target air-fuel ratio setting unit A2 corresponds to “the target air-fuel ratio acquisition unit”.

A base fuel injection amount decision unit A3 calculates a base fuel injection amount Fbase by dividing the in-cylinder intake air amount Mc(k) by the stoichiometric air-fuel ratio stoich·(1/K). This base fuel injection amount decision unit A3 corresponds to “the base fuel injection amount acquisition unit”.

An FF correction amount calculation unit A4 calculates a feedforward correction amount DFF (an FF correction amount DFF) for correcting the base fuel injection amount Fbase, which corresponds to a deviation of the upstream-side target air-fuel ratio abyfr(k) from the stoichiometric air-fuel ratio stoich·(1/K), according to an expression (1) shown below.

DFF=(Mc(k)·(stoich−abyfr(k)·K))/(stoich·abyfr(k)) (1)

This FF correction amount DFF is equal to a value obtained by subtracting an amount of fuel (=Mc(k)·K/stoich) for making the air-fuel ratio equal to the stoichiometric air-fuel ratio stoich·(1/K) from an amount of fuel (=Mc(k)/abyfr(k)) for making the air-fuel ratio equal to the upstream-side target air-fuel ratio abyfr(k). The FF correction amount DFF is positive when the upstream-side target air-fuel ratio abyfr(k) is richer than the stoichiometric air-fuel ratio (the FF correction amount DFF increases as the upstream-side target air-fuel ratio abyfr(k) becomes richer), and is negative when the upstream-side target air-fuel ratio abyfr(k) is leaner than the stoichiometric air-fuel ratio (the absolute value of the FF correction amount DFF increases as the upstream-side target air-fuel ratio abyfr(k) becomes leaner). This FF correction amount calculation unit A4 corresponds to “the feedforward correction amount acquisition unit”.

A command fuel injection amount calculation unit A5 calculates a command fuel injection amount Fi by adding the FF correction amount DFF and a feedback correction amount DFB (the FB correction amount DFB) subjected to a later-described guard processing to the base fuel injection amount Fbase. In other words, the command fuel injection amount calculation unit A5 calculates the command fuel injection amount Fi on the basis of an expression (2) shown below. This command fuel injection amount calculation unit A5 corresponds to “the command fuel injection amount calculation unit”.

Fi=Fbase+DFF+DFB (2)

In this manner, the air-fuel ratio control apparatus according to this embodiment of the invention issues to the injector 39 of a cylinder undergoing a current intake stroke a command to inject fuel in the command fuel injection amount Fi obtained by correcting the base fuel injection amount Fbase on the basis of the FF correction amount DFF and the FB correction amount DFB. A control device thus issuing the command to inject fuel corresponds to “the air-fuel ratio control unit”.

As is the case with the aforementioned upstream-side target air-fuel ratio setting unit A2, a downstream-side target value setting unit A6 decides a downstream-side target value Voxsref on the basis of the operational speed NE as the operational state of the internal combustion engine 10 and the accelerator pedal operation amount Accp. In this embodiment of the invention, this downstream-side target value Voxsref is set such that the air-fuel ratio corresponding to the downstream-side target value Voxsref coincides with the aforementioned upstream-side target air-fuel ratio abyfr(k).

An output difference amount calculation unit A7 calculates an output difference amount DVoxs by subtracting the output value Voxs of the downstream-side air-fuel ratio sensor 67 at this moment (more specifically, at the moment when the issuance of the current command to inject fuel in Fi is started) from the downstream-side target value Voxsref at this moment on the basis of an expression (3) shown below.

DVoxs=Voxsref−Voxs (3)

A PID controller A8 calculates a sub-feedback correction amount Vafsfb on the basis of an expression (4) shown below by subjecting the output difference amount DVoxs to a processing of proportion, integration, and differentiation (the PID processing). In the expression (4) shown below, Kp denotes a preset proportional gain (a constant value), Ki denotes a preset integral gain (a constant value), and Kd denotes a preset differential gain (a constant value).

Vafsfb=Kp·DVoxs+Ki·SDVoxs+K·DDVoxs (4)

In the expression (4), SDVoxs denotes a time integral value of the output difference amount DVoxs, and DDVoxs denotes a time differential value of the output difference amount DVoxs. It should be noted herein that the PID controller A8 includes an integral term Ki·SDVoxs. Therefore, the output difference amount DVoxs is zero in a steady state. In other words, the steady difference between the downstream-side target value Voxsref and the output value Voxs of the downstream-side air-fuel ratio sensor 67 is zero.

In this manner, the air-fuel ratio control apparatus according to this embodiment of the invention calculates the sub-feedback correction amount Vafsfb on the basis of the downstream-side target value Voxsref and the output value Voxs of the downstream-side air-fuel ratio sensor 67 to control the air-fuel ratio such that the steady difference between the downstream-side target value Voxsref and the output value Voxs becomes equal to zero. As will be described later, this sub-feedback correction amount Vafsfb is used to acquire a control air-fuel ratio abyfs.

A control air-fuel ratio corresponding output value calculation unit A9 calculates a control air-fuel ratio corresponding output value (Vabyfs+Vafsfb) by adding the downstream-side feedback correction amount Vafsfb to the output value Vabyfs of the upstream-side air-fuel ratio sensor 66 at this moment.

A table conversion unit A10 calculates a (current) control air-fuel ratio abyfs1(k) at this moment in the case where the alcohol concentration R=0% on the basis of the control air-fuel ratio corresponding output value (Vabyfs+Vafsfb) and a table Mapabyfs defining the relationship between the output value Vabyfs of the upstream-side air-fuel ratio sensor and the air-fuel ratio A/F, which is indicted by the solid line in the graph of FIG. 2 described above.

An air-fuel ratio conversion unit A11 then calculates the control air-fuel ratio abyfs(k) corresponding to the alcohol concentration R at this moment by multiplying the control air-fuel ratio abyfs1(k) by a value (1/K). Thus, the control air-fuel ratio abyfs(k) is different from the air-fuel ratio (the detected air-fuel ratio) obtained from the output value Vabyfs of the upstream-side air-fuel ratio sensor 66 by a value corresponding to the sub-feedback correction amount Vafsfb.

An upstream-side target air-fuel ratio delay unit A12 reads out from the RAM 73 an upstream-side target air-fuel ratio abyfr(k−N) prior to this moment by N strokes among upstream-side target air-fuel ratios abyfr calculated by the upstream-side target air-fuel ratio setting unit A2 for respective intake strokes and stored in the RAM 73. It should be noted herein that N denotes the number of strokes corresponding to the sum of “a time regarding stroke delay”, “a time regarding transport delay”, and “a time regarding response delay” (hereinafter referred to as “a dead time L”).

“The time regarding stroke delay” is a time from a moment when a command to inject fuel is issued to a moment when exhaust gas based on the combustion of the fuel injected according to this command is discharged from the combustion chamber 25 to the exhaust passage via the exhaust valve 35. “The time regarding transport delay” is a time from a moment when the exhaust gas is discharged to the exhaust passage via the exhaust valve 35 to a moment when the exhaust gas reaches (a detection portion of) the upstream-side air-fuel ratio sensor 66. “The time regarding response delay” is a time to a moment when the air-fuel ratio of the exhaust gas that has reached (the detection portion of) the upstream-side air-fuel ratio sensor 66 manifests itself as the output value Vabyfs of the upstream-side air-fuel ratio sensor 66.

An air-fuel ratio difference calculation unit A13 calculates an air-fuel ratio difference DAF by subtracting the upstream-side target air-fuel ratio abyfr(k−N) prior to this moment by N strokes from the current control air-fuel ratio abyfs(k) on the basis of an expression (5) shown below. In this case, considering that the output value Vabyfs of the upstream-side air-fuel ratio sensor 66 represents an air-fuel ratio of exhaust gas based on the combustion of fuel injected according to a command for injection prior to this moment by the dead time L, this air-fuel ratio difference DAF is an amount representing an excess or deficiency in the fuel supplied into the cylinder at a moment prior to this moment by N strokes.

DAF=abyfs(k)−abyfr(k−N) (5)

A PI controller A14 calculates an FB correction amount DFB (a value that has not been subjected to the guard processing) for compensating for the excess or deficiency in the amount of fuel supply prior to this moment by N strokes on the basis of an expression (6) shown below, by subjecting the air-fuel ratio difference DAF to a processing of proportion and integration (a PI processing).

DFB=(Gp·DAF+Gi·SDAF)·KFB (6)

In the expression (6), Gp denotes a proportional gain (a constant value), Gi denotes an integral gain (a constant value), and SDAF denotes a time integral value of the air-fuel ratio difference DAF. Although a coefficient KFB is “1” in this embodiment of the invention, the invention is not limited to this configuration. For example, the coefficient KFB may be changed on the basis of the operational speed NE, the in-cylinder intake air amount Mc, and the like. This PI controller A14 corresponds to “the feedback correction amount acquisition unit”.

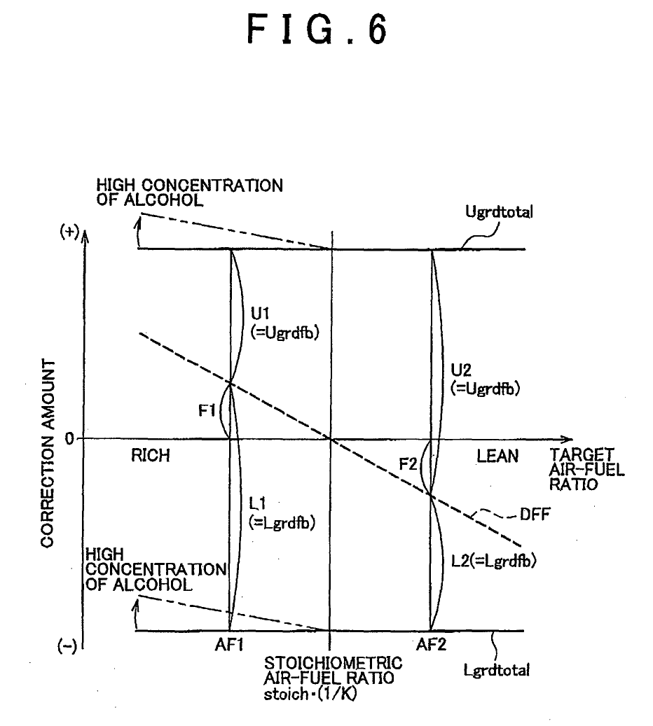

A guard processing performance unit A15 executes a processing (hereinafter referred to as “a guard processing”) of limiting the FB correction amount DFB calculated according to the expression (6) to an FB lower-limit guard value Lgrdfb (<0, corresponding to “the second feedback guard value”), which is set as will be described later, when the FB correction amount DFB drops below the FB lower-limit guard value Lgrdfb, and limiting the FB correction amount DFB calculated according to the expression (6) to an FB upper-limit guard value Ugrdfb (>0, corresponding to “the first feedback guard value”), which is set as will be described later, when the FB correction amount DFB exceeds the FB upper-limit guard value Ugrdfb. A method of setting the FB upper-limit guard value Ugrdfb and the FB lower-limit guard value Lgrdfb by the guard processing performance unit A15 will be described hereinafter with reference to FIG. 6.

In this embodiment of the invention, a total upper-limit guard value Ugrdtotal (corresponding to “the first total guard value”) and a total lower-limit guard value Lgrdtotal (corresponding to “the second total guard value”), which are indicated by thick solid lines in FIG. 6 respectively, are set in order to set the FB upper-limit guard value Ugrdfb and the FB lower-limit guard value Lgrdfb. It should be noted, however, that the thick solid lines of FIG. 6 indicate the case where the alcohol concentration R=0%.

The total upper-limit guard value Ugrdtotal corresponds to a limit value of the combustible range on the rich side (or an air-fuel ratio leaner than the limit value by a predetermined value), and the total lower-limit guard value Lgrdtotal corresponds to a limit value of the combustible range on the lean side (or an air-fuel ratio richer than the limit value by a predetermined value). That is, the total upper-limit guard value Ugrdtotal and the total lower-limit guard value Lgrdtotal correspond to “a value that “the total correction amount (the FF correction amount DFF+the FE correction amount DFB=DFF+DFB in this embodiment of the invention)” for the base fuel injection amount should not exceed” and “a value that “the total correction amount” for the base fuel injection amount should not drop below” respectively. In other words, there is a relationship “Lgrdtotal≦(DFF+DFB)≦Ugrdtotal”.

The total upper-limit guard value Ugrdtotal and the total lower-limit guard value Lgrdtotal are decided on the basis of the in-cylinder intake air amount Mc(k), the upstream-side target air-fuel ratio abyfr(k), and the alcohol concentration R, using a table MapUgrdtotal and a table MapLgrdtotal respectively, whose arguments are Mc(k), abyfr(k), and R.

The absolute values of the total upper-limit guard value Ugrdtotal and the total lower-limit guard value Lgrdtotal are so decided as to be proportional to the in-cylinder intake air amount Mc(k). This decision is based on the fact that the FB correction amount DFB is a value added to the base fuel injection amount Fbase (i.e., not a value by which the base fuel injection amount Fbase is multiplied). The following description will be continued on the assumption that the in-cylinder intake air amount Mc(k) is constant.

In the case where the alcohol concentration R=0%, the total upper-limit guard value Ugrdtotal and the total lower-limit guard value Lgrdtotal are set to different constant values (“the first predetermined value” and “the second predetermined value”) respectively as indicated by the solid lines of FIG. 6.

On the other hand, in the case where the alcohol concentration R>0%, the total upper-limit guard value Ugrdtotal and the total lower-limit guard value Lgrdtotal are so set respectively as to increase with respect to the aforementioned corresponding constant values as the alcohol concentration R increases and the target air-fuel ratio abyfr(k) shifts away from the stoichiometric air-fuel ratio toward the rich side, only when the target air-fuel ratio abyfr(k) is richer than the stoichiometric air-fuel ratio stoich·(1/K) (see alternate long and two short dashes lines of FIG. 6). This setting will be described hereinafter.

A limiting current type oxygen concentration sensor such as the upstream-side air-fuel ratio sensor 66 (as well as an electromotive force type oxygen concentration sensor such as the downstream-side air-fuel ratio sensor 67) tends to generate an output that shifts toward the rich side as the average molecular weight of reductive components (i.e., unburned fuel) decreases when the concentration of the reductive components is constant in exhaust gas whose air-fuel ratio is richer than the stoichiometric air-fuel ratio. This tendency is considered to be based on the fact that the reductive components are more likely to enter the interior of a sensor reaction portion made of (zirconia or the like) and a reaction in the sensor reaction portion is more likely to proceed as the average molecular weight of the reductive components decreases.

On the other hand, alcohol has a smaller average molecular weight than gasoline. Accordingly, the average molecular weight of fuel decreases as the alcohol concentration increases. Due to the foregoing fact, as shown in FIG. 2, the output value Vabyfs of the upstream-side air-fuel ratio sensor tends to deviate toward the rich side (the smaller side) as the alcohol concentration R increases when the air-fuel ratio of exhaust gas is richer than the stoichiometric air-fuel ratio in the relationship between the output value Vabyfs of the upstream-side air-fuel ratio sensor and the air-fuel ratio A/F (see alternate long and two short dashes lines of FIG. 2).

In addition, according to this embodiment of the invention, the air-fuel ratio (hereinafter referred to as “the detected air-fuel ratio”) is acquired on the basis of the relationship between the output value Vabyfs of the upstream-side air-fuel ratio sensor 66 and the air-fuel ratio A/F in the case where the alcohol concentration R=0% (see the solid line of FIG. 2) and the output value Vabyfs (see the table conversion unit A10). In this case, the detected air-fuel ratio tends to shift toward the rich side with respect to the actual air-fuel ratio (“the shift of the detected air-fuel ratio toward the rich side” as mentioned above) as the alcohol concentration R increases when the air-fuel ratio of exhaust gas is richer than the stoichiometric air-fuel ratio.

Furthermore, the actual air-fuel ratio is so controlled as to coincide with the target air-fuel ratio abyfr(k). Therefore, the actual air-fuel ratio is unlikely to become richer than the stoichiometric air-fuel ratio when the target air-fuel ratio abyfr(k) is leaner than the stoichiometric air-fuel ratio. That is, “the shift of the detected air-fuel ratio toward the rich side” is unlikely to occur. On the other hand, the actual air-fuel ratio is likely to become richer than the stoichiometric air-fuel ratio when the target air-fuel ratio abyfr(k) is richer than the stoichiometric air-fuel ratio. That is, “the shift of the detected air-fuel ratio toward the rich side” as mentioned above is likely to occur. This fact means that “the shift of the detected air-fuel ratio toward the rich side” as mentioned above is likely to occur when the alcohol concentration R is high and the target air-fuel ratio abyfr(k) is richer than the stoichiometric air-fuel ratio.

When “the shift of the detected air-fuel ratio toward the rich side” as mentioned above occurs, the actual air-fuel ratio is adjusted to a value shifted toward the lean side with respect to a target thereof. In this case, the actual air-fuel ratio is still shifted toward the lean side with respect to the limit of the combustible range on the rich side by a value corresponding to “the shift of the detected air-fuel ratio toward the rich side” when “the total correction amount” (=DFF+DFB) for the base fuel injection amount is equal to the aforementioned constant value corresponding to the total upper-limit guard value Ugrdtotal. This phenomenon means that there is a room for setting (correcting) the total upper-limit guard value Ugrdtotal larger than the aforementioned constant value by the value corresponding to “the shift of the detected air-fuel ratio toward the rich side” (i.e., there is a room for increasing the guard width in the gain direction).

On the other hand, in the case where the actual air-fuel ratio is adjusted to a value shifted toward the lean side with respect to the target thereof, the actual air-fuel ratio is shifted toward the lean side with respect to the limit of the combustible range on the lean side by a value corresponding to “the shift of the detected air-fuel ratio toward the rich side” when “the total correction amount” (=DFF+DFB) for the base fuel injection amount is equal to the aforementioned constant value corresponding to the total lower-limit guard value Lgrdtotal. That is, even when “the total correction amount” (=DFF+DFB) has not dropped below the total lower-limit guard value Lgrdtotal, a problem such as deviation of the air-fuel ratio from the combustible range toward the lean side or the like can be caused. In this case, there is a need to set (correct) the total lower-limit guard value Lgrdtotal larger than the aforementioned constant value by the value corresponding to “the shift of the detected air-fuel ratio toward the rich side” (there is a need to reduce the guard width in the loss direction).

Furthermore, the magnitude of “the shift of the detected air-fuel ratio toward the rich side” increases as the alcohol concentration R increases. The magnitude of “the shift of the detected air-fuel ratio toward the rich side” increases the actual air-fuel ratio shifts away from the stoichiometric air-fuel ratio toward the rich side (see the magnitude of the discrepancy between the solid line and the alternate long and two short dashes lines in FIG. 2). It should be noted herein that the actual air-fuel ratio also tends to shift away from the stoichiometric air-fuel ratio toward the rich side as the target air-fuel ratio abyfr(k) shifts away from the stoichiometric air-fuel ratio toward the rich side. That is, the magnitude of “the shift of the detected air-fuel ratio toward the rich side” increases as the target air-fuel ratio abyfr(k) shifts away from the stoichiometric air-fuel ratio toward the rich side.

With an eye to the foregoing, in the air-fuel ratio control apparatus according to this embodiment of the invention, the total upper-limit guard value Ugrdtotal and the total lower-limit guard value Lgrdtotal are so set respectively as to increase with respect to the aforementioned corresponding constant values as the alcohol concentration R increases and the target air-fuel ratio abyfr(k) shifts away from the stoichiometric air-fuel ratio toward the rich side only when the target air-fuel ratio abyfr(k) is richer than the stoichiometric air-fuel ratio.

The FB upper-limit guard value Ugrdfb and the FB lower-limit guard value Lgrdfb are set according to expressions (7) and (8) shown below respectively, using the total upper-limit guard value Ugrdtotal set as described above, the total lower-limit guard value Lgrdtotal set as described above, and the FF correction amount DFF.

Ugrdfb=Ugrdtotal−DFF (7)

Lgrdfb=Lgrdtotal−DFF (8)

That is, the FB upper-limit guard value Ugrdfb is decided as a value equal to the FB correction amount DFB corresponding to a case where the sum of the FB correction amount DFB and the FF correction amount DFF coincides with the total upper-limit guard value Ugrdtotal, and the FB lower-limit guard value Lgrdfb is decided as a value equal to the FB correction amount DFB corresponding to a case where the sum of the FB correction amount DFB and the FF correction amount DFF coincides with the total lower-limit guard value Lgrdtotal.

For example, as shown in FIG. 6, when the target air-fuel ratio abyfr(k) assumes a value AF1 (a rich air-fuel ratio) (when the FF correction amount DFF assumes a value F1 (a positive value)), the FB upper-limit guard value Ugrdfb is equal to a value U1 (a positive value), and the FB lower-limit guard value Lgrdfb is equal to a value (−L1) (a negative value). By the same token, when the target air-fuel ratio abyfr(k) assumes a value AF2 (a lean air-fuel ratio) (when the FF correction amount DFF assumes a value (−F2) (a negative value)), the FB upper-limit guard value Ugrdfb is equal to a value U2 (a positive value), and the FB lower-limit guard value Lgrdfb is equal to a value (−L2) (a negative value).

The FB correction amount DFB calculated according to the expression (6) is subjected to the guard processing using the FB upper-limit guard value Ugrdfb thus set and the FB lower-limit guard value Lgrdfb thus set. The FB correction amount DFB subjected to the guard processing is then used in calculating the command fuel injection amount Fi by means of the command fuel injection amount calculation unit A5 as described above.

Thus, the occurrence of a problem such as deviation of the air-fuel ratio from the combustible range regardless of the values of the alcohol concentration R and the FF correction amount DFF or the like can be reliably prevented while holding the difference between the FB upper-limit guard value Ugrdfb and the FB lower-limit guard value Lgrdfb (i.e., the guard width) as large as possible. This guard processing performance unit A15 corresponds to “the guard processing performance unit” as mentioned above.

As described above, the alcohol concentration sensor 69 as an alcohol concentration acquisition unit A16 acquires/updates the alcohol concentration R (0≦R≦100 (%) of fuel accumulated in the fuel tank (not shown) at each predetermined timing, and acquires/updates the coefficient K on the basis of the table shown in FIG. 4. The coefficient K thus acquired/updated is used by the upstream-side target air-fuel ratio setting unit A2, the FF correction amount calculation unit A4, and the guard processing performance unit A15.

As is apparent from the foregoing description, in the air-fuel ratio control apparatus according to this embodiment of the invention, the air-fuel ratio is feedback-controlled such that the control air-fuel ratio abyfs(k) at this moment coincides with the upstream-side target air-fuel ratio abyfr(k−N) prior to this moment by N strokes, with a view to compensating for an excess or deficiency in the amount of fuel supplied into the cylinder at a moment prior to this moment by N strokes.

In addition, as described above, the control air-fuel ratio abyfs is obtained by correcting the detected air-fuel ratio obtained from the output value Vabyfs of the upstream-side air-fuel ratio sensor 66 by a value corresponding to the sub-feedback correction amount Vafsfb. Accordingly, the control air-fuel ratio abyfs changes in accordance with the output difference amount DVoxs as well. As a result, the air-fuel ratio is feedback-controlled also such that the output value Voxs of the downstream-side air-fuel ratio sensor 67 coincides with the downstream-side target value Voxsref.

In addition, the PI controller A13 includes the integral term Gi·SDAF. The air-fuel ratio difference DAF is therefore ensured to be zero in a steady state. In other words, the steady difference between the upstream-side target air-fuel ratio abyfr(k−N) and the control air-fuel ratio abyfs(k) is zero. This means that the control air-fuel ratio abyfs is ensured to coincide with the upstream-side target air-fuel ratio abyfr in the steady state and hence that the air-fuel ratios upstream and downstream of the first catalyst 53 are ensured to coincide with the upstream-side target air-fuel ratio abyfr in the steady state.

In the steady state, the proportional term Gp·DAF is zero because the air-fuel ratio difference DAF is zero. Therefore, the FB correction value DFB is equal to the value of the integral term Gi·SDAF. The value of this integral term Gi·SDAF corresponds to “an error of the base fuel injection amount”. Thus, “the error of the base fuel injection amount” can be compensated for. The foregoing description is the outline of air-fuel ratio control performed by the air-fuel ratio control apparatus according to this embodiment of the invention.

Next, the actual performance of the air-fuel ratio control apparatus according to this embodiment of the invention will be described. In the following description, for convenience of explanation, it is assumed that “MapX(a1, a2, . . . ) denotes a table for calculating a value X whose argument is a1, a2, . . . In the case where the value of the argument is equal to a detection value of the sensor, a current detection value of the sensor is used.

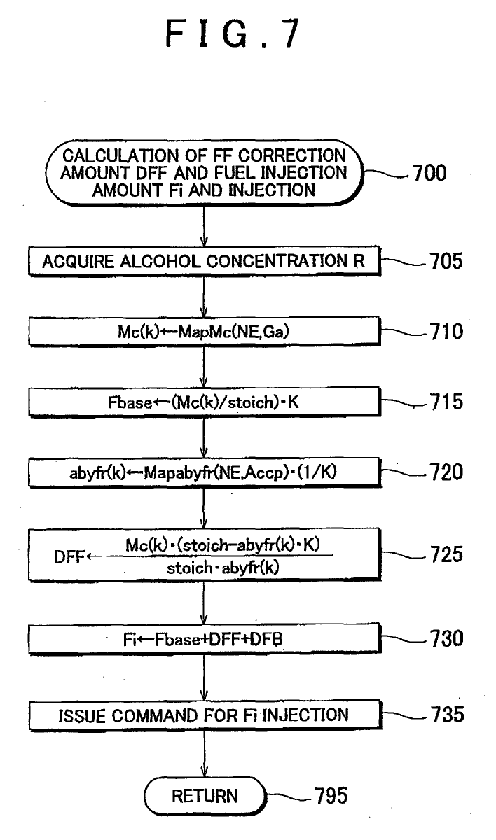

The CPU 71 repeatedly executes a routine for calculating the FF correction amount DFF and the command fuel injection amount Fi and issuing a command to inject fuel, which is shown as a flowchart in FIG. 7, every time the crank angle of each cylinder becomes equal to a predetermined crank angle prior to each intake top dead center (e.g., BTDC90° CA). Accordingly, when the crank angle of any cylinder becomes equal to the aforementioned predetermined crank angle, the CPU 71 starts processings from step 700, and proceeds to step 705 to acquire the alcohol concentration R obtained from the alcohol concentration sensor 69 and acquire the coefficient K on the basis of the table shown in FIG. 4.

The CPU 71 then proceeds to step 710 to estimate/decide the current in-cylinder intake air amount Mc(k), namely, an amount of air taken into a cylinder undergoing a intake stroke at this time (which may be referred to hereinafter also as “a fuel injection cylinder”) on the basis of a table MapMc(NE, Ga).

The CPU 71 then proceeds to step 715 to decide the base fuel injection amount Fbase by dividing the in-cylinder intake air amount Mc(k) by the stoichiometric air-fuel ratio stoich·(1/K). The CPU 71 then proceeds to step 720 to calculate the target air-fuel ratio at the time when the alcohol concentration R=0% on the basis of a table Mapabyfr(NE, Accp) and decide the current upstream-side target air-fuel ratio abyfr(k) by multiplying the calculated target air-fuel ratio by the value (1/K).

The CPU 71 then proceeds to step 725 to calculate the FF correction amount DFF on the basis of the in-cylinder intake air amount Mc(k), the upstream-side target air-fuel ratio abyfr(k), and the expression (1). The CPU 71 then proceeds to step 730 to decide the command fuel injection amount Fi by adding the FF correction amount DFF and the latest FB correction amount DFB (subjected to the guard processing) calculated in a later-described routine (at the moment of the last fuel injection) to the base fuel injection amount Fbase according to the expression (2).

The CPU 71 then proceeds to step 735 to issue a command to inject fuel in the command fuel injection amount Fi, and thereafter proceeds to step 795 to temporarily terminate the present routine. Owing to the foregoing procedure, the command to inject fuel in the command fuel injection amount Fi, which is obtained after the base fuel injection amount Fbase is subjected to the FF correction and the FB correction, is issued to the fuel injection cylinder.

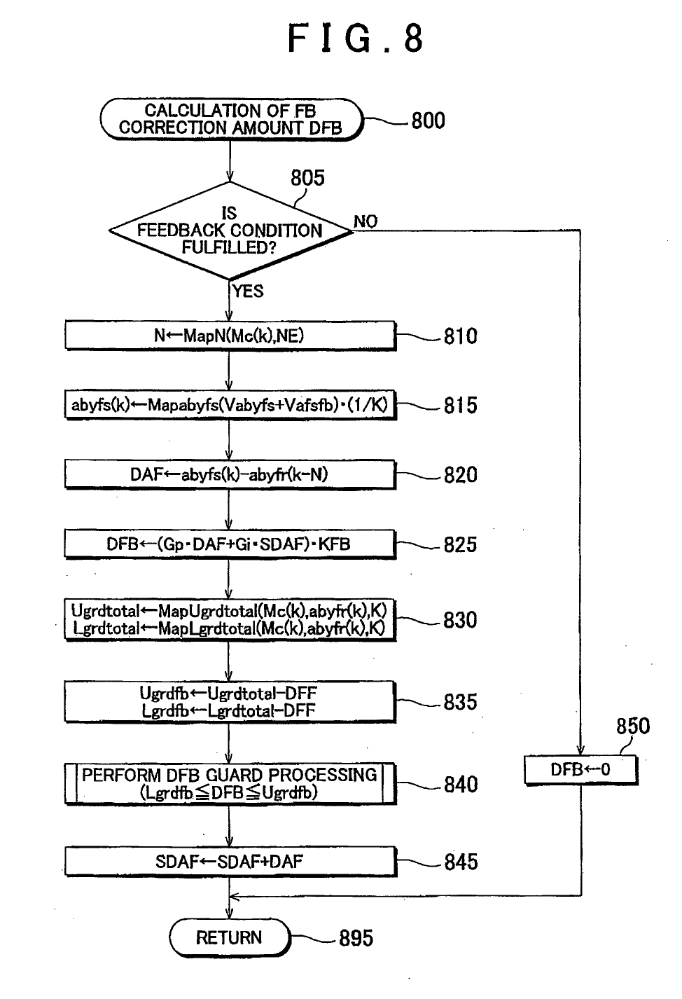

Next, the calculation of the FB correction amount DFB (subjected to the guard processing) will be described. The CPU 71 repeatedly executes a routine shown as a flowchart in FIG. 8 with each advent of a fuel injection start timing (a moment for starting fuel injection) as to the fuel injection cylinder. Accordingly, with the advent of the fuel injection start timing as to the fuel injection cylinder, the CPU 71 starts processings from step 800 and proceeds to step 805 to determine whether or not a feedback condition is fulfilled. The feedback condition is fulfilled when, for example, the coolant temperature THW of the engine is equal to or higher than a first predetermined temperature, the upstream-side air-fuel ratio sensor 66 is normal (including an activated state thereof), and the in-cylinder intake air amount Mc(k) (or an intake load) is equal to or smaller than a predetermined value.

Now, the description will be continued on the assumption that the feedback condition is fulfilled. The CPU 71 makes a determination of “Yes” in step 805 and proceeds to step 810 to decide the stroke number N on the basis of a table MapN(Mc(k), NE). The stroke number N decreases as the in-cylinder intake air amount Mc(k) increases or the operational speed NE increases.

The CPU 71 then proceeds to step 815 to calculate the control air-fuel ratio abyfs1(k) at the time when the alcohol concentration R=0% (see the solid line of FIG. 2) by converting a resultant air-fuel ratio corresponding output value (Vabyfs+Vafsfb) as the sum of the output value Vabyfs of the upstream-side air-fuel ratio sensor 66 at this moment and the latest value of the sub-feedback correction amount Vafsfb calculated in a later-described routine on the basis of a table Mapabyfs(Vabyfs+Vafsfb), and calculates the (current) control air-fuel ratio abyfs(k) by multiplying the calculated control air-fuel ratio abyfs1(k) by the value (1/K).

The CPU 71 then proceeds to step 820 to calculate the air-fuel ratio difference DAF by subtracting the upstream-side target air-fuel ratio abyfr(k−N) from the control air-fuel ratio abyfs(k) according to the expression (5), and then calculates the FB correction amount DFB on the basis of the expression (6) in step 825.

The CPU 71 then proceeds to step 830 to decide the total upper-limit guard value Ugrdtotal on the basis of a table MapUgrdtotal(Mc(k), abyfr(k), K) and decide the total lower-limit guard value Lgrdtotal on the basis of a table MapLgrdtotal(Mc(k), abyfr(k), K).

The CPU 71 then proceeds to step 835 to calculate the FB upper-limit guard value Ugrdfb on the basis of the total upper-limit guard value Ugrdtotal, the FF correction amount DFF calculated earlier in step 725, and the expression (7) and calculate the FB lower-limit guard value Lgrdfb on the basis of the total lower-limit guard value Lgrdtotal, the FF correction amount DFF, and the expression (8).

The CPU 71 then proceeds to step 840 to subject the FB correction amount DFB calculated in step 825 to the “guard processing” as mentioned above (the FB lower-limit guard value Lgrdfb≦DFB≦the FB tipper-limit guard value Ugrdfb), then calculates an integral value SDAF of a new air-fuel ratio difference by adding the air-fuel ratio difference DAF calculated in step 820 to the integral value SDAF of the air-fuel ratio difference DAF at that moment in step 845, and thereafter proceeds to step 895 to temporarily terminate the present routine.

Owing to the foregoing procedure, the FB correction amount DFB subjected to the guard processing is calculated. This FB correction amount DFB subjected to the guard processing is reflected on the command fuel injection amount Fi in step 730 of FIG. 7 as mentioned above, and air-fuel ratio feedback control is thereby performed.

On the other hand, when the feedback condition is not fulfilled at the time of the determination in step 805, the CPU 71 makes a determination of “No” in step 805, proceeds to step 850 to set the value of the FB correction amount DFB to “0”, and thereafter proceeds to step 895 to temporarily terminate the present routine. In this manner, when the feedback condition is not fulfilled, the FB correction amount DFB is set to “0” to refrain from making the FB correction of the base fuel injection amount Fbase.

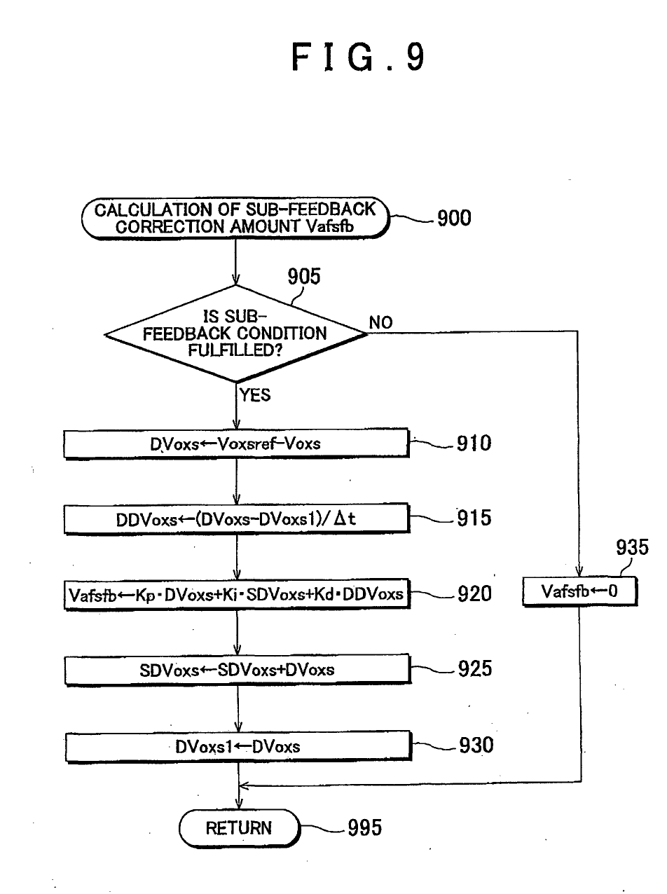

Next, the calculation of the sub-feedback correction amount Vafsfb will be described. The CPU 71 repeatedly executes a routine shown as a flowchart in FIG. 9 with each advent of the fuel injection start timing (the moment for starting fuel injection) as to the fuel injection cylinder.

Accordingly, with the advent of the fuel injection start timing as to the fuel injection cylinder, the CPU 71 starts processings from step 900 and proceeds to step 905 to determine whether or not a sub-feedback condition is fulfilled. The sub-feedback condition is fulfilled when, for example, the coolant temperature THW of the engine is equal to or higher than a second predetermined temperature higher than the first predetermined temperature in addition to the main feedback condition of step 805 as mentioned above.

Now, the description will be continued on the assumption that the sub-feedback condition is fulfilled. The CPU 71 makes a determination of “Yes” in step 905 and proceeds to step 910 to calculate the output difference amount DVoxs by subtracting the output value Voxs of the downstream-side air-fuel ratio sensor 67 at this moment from the downstream-side target value Voxsref according to the expression (3). The CPU 71 then proceeds to step 915 to calculate a differential value DDVoxs of the output difference amount DVoxs on the basis of an expression (9) shown below.

DDVoxs=(DVoxs−DVoxs1)/Δt (9)

In the expression (9), DVoxs1 denotes a last value of the output difference amount DVoxs updated in step 830, which will be described later, during the last execution of the present routine. In this expression, Δt denotes a time from a moment of the last execution of the present routine to a moment of the current execution of the present routine.

The CPU 71 then proceeds to step 920 to calculate the sub-feedback correction amount Vafsfb on the basis of the expression (4).

The CPU 71 then proceeds to step 925 to calculate the integral value SDVoxs of a new output difference amount by adding the output difference amount DVoxs calculated in step 910 as mentioned above to the integral value SDVoxs of the output difference amount at that moment, then sets the last value DVoxs1 of the output difference amount DVoxs equal to the output difference amount DVoxs calculated in step 910 as mentioned above in step 930, and thereafter proceeds to step 995 to temporarily terminate the present routine.

Owing to the foregoing procedure, the sub-feedback correction amount Vafsfb is calculated. This sub-feedback correction amount Vafsfb is used to calculate the control air-fuel ratio abyfs in step 815 during the subsequent execution of the aforementioned routine of FIG. 8.

On the other hand, when the sub-feedback condition is not fulfilled at the time of the determination of step 905, the CPU 71 makes a determination of “No” in this step 905, proceeds to step 935 to set the value of the sub-feedback correction amount Vafsfb to “0”, and proceeds to step 995 to temporarily terminate the present routine. In this manner, when the sub-feedback condition is not fulfilled, the sub-feedback correction amount Vafsfb is set to “0” to refrain from performing air-fuel ratio feedback control based on sub-feedback control.

As described above, according to the air-fuel ratio control apparatus for the internal combustion engine according to this embodiment of the invention, the FF correction amount DFF (in units of g) obtained in accordance with the deviation of the target air-fuel ratio abyfr from the stoichiometric air-fuel ratio and the FB correction amount DFB (in units of g) subjected to the guard processing, which is obtained on the basis of the output value Vabyfs of the upstream-side air-fuel ratio sensor 66, are added to the base fuel injection amount Fbase (in units of g) corresponding to the stoichiometric air-fuel ratio stoich·(1/K) to decide the command fuel injection amount Fi. The guard processing of the FB correction amount DFB is performed with the FB upper-limit guard value Ugrdfb (a positive value in units of g) and the FB lower-limit guard value (a negative value in units of g) serving as an upper limit and a lower limit respectively. The FB upper-limit guard value Ugrdfb is set to a value (Ugrdtotal−DFF) obtained by subtracting the FF correction amount DFF from the upper limit that the total correction amount (DFF+DFB) for the base fuel injection amount should not exceed (the total upper-limit guard value Ugrdtotal (a positive constant value in units of g)), and the FB lower-limit guard value Lgrdfb is set to a value (Lgrdtotal−DFF) obtained by subtracting the FF correction amount DFF from the lower limit that the total correction amount (DFF+DFB) for the aforementioned base fuel injection amount should not drop below (the total lower-limit guard value Lgrdtotal (a negative constant value in units of g)).

In addition, considering that “the shift of the detected air-fuel ratio toward the rich side” as mentioned above is likely to occur when the target air-fuel ratio abyfr(k) is richer than the stoichiometric air-fuel ratio due to the influence of alcohol components in fuel, the total upper-limit guard value Ugrdtotal and the total lower-limit guard value Lgrdtotal are so set (corrected) respectively as to increase with respect to the aforementioned corresponding constant values as the alcohol concentration R increases and the target air-fuel ratio abyfr(k) shifts away from the stoichiometric air-fuel ratio toward the rich side only when the target air-fuel ratio abyfr(k) is richer than the stoichiometric air-fuel ratio.

Thus, the occurrence of a problem such as deviation of the air-fuel ratio from the combustible range or the like can be prevented regardless of the values of the alcohol concentration R and the FF correction amount DFF while holding the difference between the FB upper-limit guard value Ugrdfb and the FB lower-limit guard value Lgrdfb (i.e., the guard width) as large as possible.

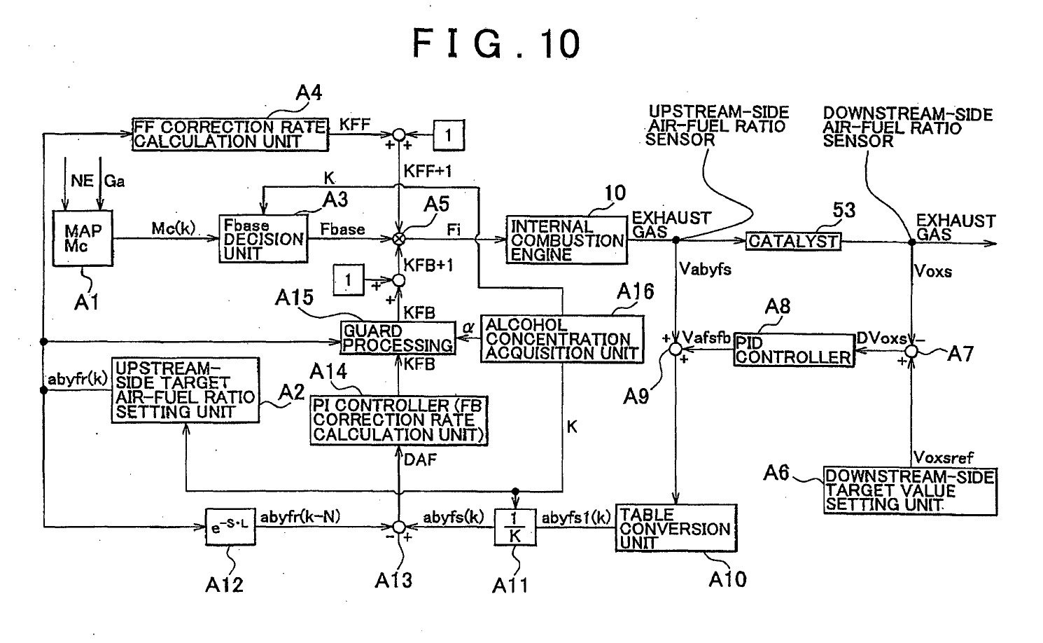

Next, the air-fuel ratio control apparatus according to the second embodiment of the invention will be described. FIG. 10 is a functional block diagram of the air-fuel ratio control apparatus according to the second embodiment of the invention. As shown in FIG. 10, the second embodiment of the invention is different from the first embodiment of the invention whose functional block diagram is shown in FIG. 5 in that the command fuel injection amount Fi is decided by multiplying the base fuel injection amount Fbase (in units of g) by a value (KFF+1) obtained by adding “1” to an FF correction rate KFF (in units of %) obtained in accordance with a deviation of the target air-fuel ratio abyfr from the stoichiometric air-fuel ratio stoich and an FB correction rate KFB (in units of %) subjected to the guard processing, which is obtained on the basis of the output value Vabyfs of the upstream-side air-fuel ratio sensor 66. The actual performance of the air-fuel ratio control apparatus according to the second embodiment of the invention will be described hereinafter as to this difference.

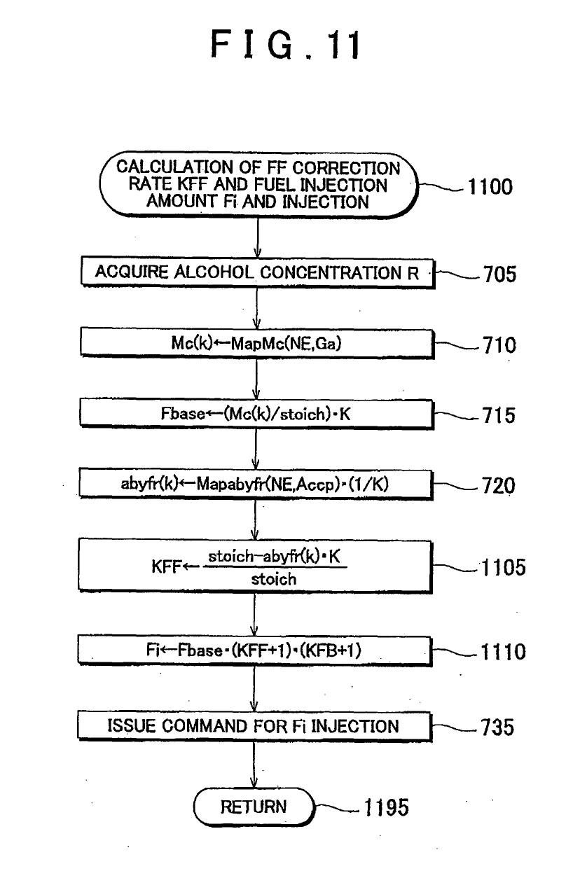

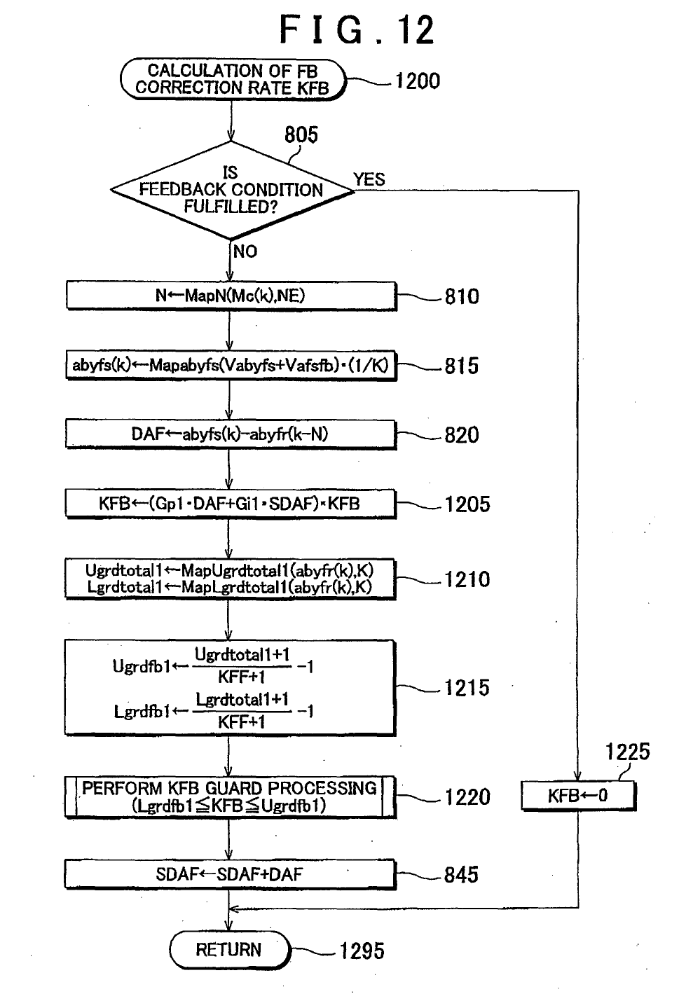

The CPU 71 of the second embodiment of the invention executes the routine of FIG. 9, which is one of the routines of FIGS. 7 to 9 executed by the CPU 71 of the foregoing first embodiment of the invention, without any modification, and executes routines shown as flowcharts in FIGS. 11 and 12 instead of the routines of FIGS. 7 and 8 respectively. In the following description, those steps in the routines of FIGS. 11 and 12 which are the same as in the aforementioned routines will be accompanied by the same step numbers as in the aforementioned routines and will not be described any further.

FIG. 11 is a routine corresponding to FIG. 7. The routine of FIG. 11 is different from the routine of FIG. 7 only in that steps 1105 and 1110 replace steps 725 and 730 of FIG. 7 respectively.

In step 1105, the FF correction rate KFF (corresponding to “the feedforward correction amount” as mentioned above) for correcting the base fuel injection amount Fbase, which corresponds to the deviation of the upstream-side target air-fuel ratio abyfr(k) from the stoichiometric air-fuel ratio stoich·(1/K), is calculated according to an expression (10) shown below.

KFF=(stoich−abyfr(k)·K)/stoich (10)

This FF correction rate KFF is equal to the ratio of the amount of deviation of the upstream-side target air-fuel ratio abyfr(k) from the stoichiometric air-fuel ratio stoich·(1/K) to the stoichiometric air-fuel ratio stoich·(1/K). As is the case with the FF correction amount DFF in the foregoing first embodiment of the invention, the FF correction rate KFF assumes a positive value when the upstream-side target air-fuel ratio abyfr(k) is richer than the stoichiometric air-fuel ratio (the FF correction rate KFF increases as the upstream-side target air-fuel ratio abyfr(k) becomes richer), and assumes a negative value when the upstream-side target air-fuel ratio abyfr(k) is leaner than the stoichiometric air-fuel ratio (the absolute value of the FF correction rate KFF increases as the upstream-side target air-fuel ratio abyfr(k) becomes leaner).

In step 1110, the command fuel injection amount Fi is calculated according to an expression (11) shown below. In the expression (11) shown below, Fbase denotes a value obtained in step 715 of FIG. 11, and KFF denotes a value obtained in step 1105 of FIG. 11. In the expression (11) shown below, the FB correction rate KFB is a value (a latest value) calculated in the later-described routine of FIG. 12.

Fi=Fbase·(KFF+1)·(KFB+1) (11)

FIG. 12 is a routine corresponding to FIG. 8. The routine of FIG. 12 is different from the routine of FIG. 8 only in that steps 1205 to 1220 and 1225 replace steps 825 to 840 and 850 of FIG. 8 respectively.

In step 1205, the FB correction rate KFB (in units of %) corresponding to the FB correction amount DFB (in units of g) in the foregoing first embodiment of the invention is calculated by subjecting the air-fuel ratio difference DAF obtained in step 820 to the PI processing using a proportional gain Gp1 and an integral gain Gi1.

In step 1210, a total upper-limit guard value Ugrdtotal1 (a positive value in units of %) corresponding to the total upper-limit guard value Ugrdtotal (in units of g) in the foregoing first embodiment of the invention is decided on the basis of a table MapUgrdtotal1(abyfr(k), K), and a total lower-limit guard value (a negative value in units of %) corresponding to the total lower-limit guard value Lgrdtotal (in units of g) in the foregoing first embodiment of the invention is decided on the basis of a table MapLgrdtotal1(abyfr(k), K). In this case, there is a relationship “(Lgrdtotal1+1)≦((KFF+1)·(KFB+1))≦(Ugrdtotal1+1)”. This relationship corresponds to the relationship “Lgrdtotal≦(DFF+DFB)≦Ugrdtotal” in the foregoing first embodiment of the invention.

The in-cylinder intake air amount Mc(k) is used as the argument of the tables MapUgrdtotal and MapLgrdtotal in the foregoing first embodiment of the invention, but is not included as an argument of the tables MapUgrdtotal1 and MapLgrdtotal1 in this embodiment of the invention. This configuration is based on the fact that the FB correction rate KFB is not influenced by the value of the in-cylinder intake air amount Mc itself because the base fuel injection amount Fbase is multiplied by the value (KFB+1) obtained by adding “1” to the FB correction rate KFB.

Thus, as is the case with the total upper-limit guard value Ugrdtotal and the total lower-limit guard value Lgrdtotal in the foregoing first embodiment of the invention, the total upper-limit guard value Ugrdtotal1 and the total lower-limit guard value Lgrdtotal1 are set to different constant values (“the first predetermined value” as mentioned above and “the second predetermined value” as mentioned above) respectively when the target air-fuel ratio abyfr(k) is leaner than the stoichiometric air-fuel ratio, and are so set (corrected) respectively as to increase with respect to the aforementioned corresponding constant values as the alcohol concentration R increases and the target air-fuel ratio abyfr(k) shifts away from the stoichiometric air-fuel ratio toward the rich side when the target air-fuel ratio abyfr(k) is richer than the stoichiometric air-fuel ratio.

In step 1215, an FB upper-limit guard value Ugrdfb1 (in units of %) corresponding to the FB upper-limit guard value Ugrdfb (in units of g) in the foregoing first embodiment of the invention is calculated according to an expression (12) shown below, and an FB lower-limit guard value Lgrdfb1 (in units of %) corresponding to the FB lower-limit guard value Lgrdfb (in units of g) in the foregoing first embodiment of the invention is calculated according to an expression (13) shown below.

Ugrdfb1=(Ugrdtotal1+1)/(KFF+1)−1 (12)

Lgrdfb1=(Lgrdtotal1+1)/(KFF+1)−1 (13)

The expression (12) is obtained by solving as to Ugrdfb1 an expression where KFB is replaced with Ugrdfb1 and the inequality sign is replaced with an equality sign in “((KFF+1)·(KFB+1))≦(Ugrdtotal1+1)” as part of the aforementioned relationship “(Lgrdtotal1+1)≦((KFF+1)·(KFB+1))≦(Ugrdtotal1+1)”. By the same token, the expression (13) is obtained by solving as to Lgrdfb1 an expression where KFB is replaced with Lgrdfb1 and the inequality sign is replaced with an equality sign in “(Lgrdtotal1+1)≦((KFF+1)·(KFB+1))”.

In step 1220, the FB correction rate KFB calculated in step 1205 is subjected to the guard processing (the FB lower-limit guard value Lgrdfb1≦KFB≦the FB upper-limit guard value Ugrdfb1). In step 1225, the FB correction rate KFB is set to “0” instead of the FB correction amount DFB.

As described above, according to this embodiment of the invention, the command fuel injection amount Fi is decided by multiplying the base fuel injection amount Fbase (in units of g) corresponding to the stoichiometric air-fuel ratio stoich·(1/K) by the value (KFF+1) obtained by adding “1” to the FF correction rate KFF (in units of %) obtained in accordance with the deviation of the target air-fuel ratio abyfr from the stoichiometric air-fuel ratio and the value (KFB+1) obtained by adding “1” to the FB correction rate KFB (in units of %) subjected to the guard processing, which is obtained on the basis of the output value Vabyfs of the upstream-side air-fuel ratio sensor 66. The guard processing of the FB correction rate KFB is performed with the FB upper-limit guard value Ugrdfb1 (in units of %) and the FB lower-limit guard value Lgrdfb1 (in units of %) sewing as an upper limit and a lower limit respectively. The FB upper-limit guard value Ugrdfb1 is set according to the expression (12) using an upper limit (Ugrdtotal1+1: a constant value) that the total correction amount ((KFF+1)·(KFB+1)) for the base fuel injection amount should not exceed and the FF correction rate KFF, and the FB lower-limit guard value Lgrdfb1 is set according to the expression (13) using a lower limit (Lgrdtotal1+1: a constant value) that the total correction amount ((KFF+1)·(KFB+1)) for the aforementioned base fuel injection amount should not drop below and the FF correction rate KFF.

In addition, considering that “the shift of the detected air-fuel ratio toward the rich side” as mentioned above is likely to occur when the target air-fuel ratio abyfr(k) is richer than the stoichiometric air-fuel ratio due to the influence of alcohol components in fuel, the total upper-limit guard value Ugrdtotal1 (i.e., the upper limit (Ugrdtotal1+1)) and the total lower-limit guard value Lgrdtotal1 (i.e., the lower limit (Lgrdtotal1+1)) are so set (corrected) respectively as to increase with respect to the aforementioned corresponding constant values as the alcohol concentration R increases and the target air-fuel ratio abyfr(k) shifts away from the stoichiometric air-fuel ratio toward the rich side only when the target air-fuel ratio abyfr(k) is richer than the stoichiometric air-fuel ratio.

Thus, this embodiment of the invention achieves an effect similar to that of the foregoing first embodiment of the invention. That is, the occurrence of a problem such as deviation of the air-fuel ratio from the combustible range or the like can be prevented regardless of the values of the alcohol concentration R and the FF correction rate KFF while holding the difference between the FB upper-limit guard value Ugrdfb1 and the FB lower-limit guard value Lgrdfb1 (i.e., the guard width) as large as possible.

The invention is not limited to the foregoing first embodiment thereof or the foregoing second embodiment thereof, and various modification examples can be adopted within the scope of the invention. For example, in each of the foregoing first embodiment of the invention and the foregoing second embodiment of the invention, the total upper-limit guard value and the total lower-limit guard value are so corrected as to increase as the alcohol concentration R increases and the target air-fuel ratio abyfr(k) shifts away from the stoichiometric air-fuel ratio toward the rich side, and the FB upper-limit guard value and the FB lower-limit guard value are thereby indirectly corrected to larger values. However, it is also appropriate to adopt a configuration in which the FB upper-limit guard value and the FB lower-limit guard value are directly corrected to larger values without correcting the total upper-limit guard value and the total lower-limit guard value respectively.

In each of the foregoing first embodiment of the invention and the foregoing second embodiment of the invention, the total upper-limit guard value and the total lower-limit guard value are so corrected as to increase in accordance with the alcohol concentration R as the target air-fuel ratio abyfr(k) shifts away from the stoichiometric air-fuel ratio toward the rich side. However, it is also appropriate to adopt a configuration in which the total upper-limit guard value and the total lower-limit guard value are so corrected as to increase in accordance with the alcohol concentration R as the target air-fuel ratio abyfr(k−N) shifts away from the stoichiometric air-fuel ratio toward the rich side.

In each of the foregoing first embodiment of the invention and the foregoing second embodiment of the invention, the total upper-limit guard value and the total lower-limit guard value are so corrected as to increase as the alcohol concentration R increases and the target air-fuel ratio abyfr(k) shifts away from the stoichiometric air-fuel ratio toward the rich side only when the target air-fuel ratio abyfr(k) is richer than the stoichiometric air-fuel ratio. However, it is also appropriate to adopt a configuration in which the total upper-limit guard value and the total lower-limit guard value are so corrected as to increase as the alcohol concentration R increases regardless of the target air-fuel ratio abyfr(k).

In each of the foregoing first embodiment of the invention and the foregoing second embodiment of the invention, sub-feedback control based on the output value Voxs of the downstream-side air-fuel ratio sensor 67 is performed. However, it is also appropriate to adopt a configuration in which sub-feedback control is not performed.

1. An air-fuel ratio control apparatus for an internal combustion engine, comprising:
an air-fuel ratio sensor that is provided in an exhaust passage of the internal combustion engine, and that outputs an air-fuel ratio of gas in the exhaust passage;
an alcohol concentration sensor that detects an alcohol concentration as a concentration of alcohol components contained in fuel;
a fuel injection device that injects fuel based on a command to inject fuel in a command fuel injection amount;
a base fuel injection amount acquisition unit that determines a base fuel injection amount based on an amount of air taken into a combustion chamber of the internal combustion engine in an intake stroke and a reference air-fuel ratio;
a target air-fuel ratio acquisition unit that determines a target air-fuel ratio of the internal combustion engine based on an operational state of the internal combustion engine;
a feedforward correction amount acquisition unit that determines a feedforward correction amount for correcting the base fuel injection amount based on a deviation of the target air-fuel ratio from the reference air-fuel ratio;
a feedback correction amount acquisition unit that determines a feedback correction amount for correcting the base fuel injection amount based on an output value of the air-fuel ratio sensor;
a guard processing execution unit that executes a guard processing for limiting the feedback correction amount to a first feedback guard value if the feedback correction amount exceeds the first feedback guard value and limiting the feedback correction amount to a second feedback guard value if the feedback correction amount drops below the second feedback guard value;
a command fuel injection amount calculation unit that calculates the command fuel injection amount by correcting the base fuel injection amount based on the feedforward correction amount and the feedback correction amount subjected to the guard processing; and
an air-fuel ratio control unit that controls an air-fuel ratio of a mixture supplied to the combustion chamber such that the air-fuel ratio of the mixture coincides with the target air-fuel ratio by issuing a command to the fuel injection device to inject fuel in the command fuel injection amount, wherein
the guard processing execution unit sets the first feedback guard value and the second feedback guard value based on the alcohol concentration and the feedforward correction amount.

2. The air-fuel ratio control apparatus according to claim 1, wherein the base fuel injection amount acquisition unit calculates the base fuel injection amount by dividing the amount of air taken into the combustion chamber of the internal combustion engine by the reference air-fuel ratio.

3. The air-fuel ratio control apparatus according to claim 1, wherein the guard processing execution unit:
sets a first total guard value that is an upper limit of a total correction amount for the base fuel injection amount and a second total guard value that is a lower limit of the total correction amount based on the alcohol concentration when the target air-fuel ratio is richer than the reference air-fuel ratio, wherein the total correction amount is calculated based on the feedback correction amount and the feedforward correction amount;
sets the first feedback guard value to a value equal to a feedback correction amount corresponding to a case where the total correction amount coincides with the first total guard value; and
sets the second feedback guard value to a value equal to a feedback correction amount corresponding to a case where the total correction amount coincides with the second total guard value.

4. The air-fuel ratio control apparatus according to claim 3, wherein the guard processing execution unit:
sets the first total guard value to a first predetermined value when the target air-fuel ratio is leaner than the reference air-fuel ratio, and increases the first total guard value from the first predetermined value, as the alcohol concentration increases or the target air-fuel ratio shifts away from the reference air-fuel ratio toward a rich side when the target air-fuel ratio is richer than the reference air-fuel ratio; and
sets the second total guard value to a second predetermined value when the target air-fuel ratio is leaner than the reference air-fuel ratio, and increases the second predetermined value from the second predetermined value, as the alcohol concentration increases or the target air-fuel ratio shifts away from the reference air-fuel ratio toward the rich side when the target air-fuel ratio is richer than the reference air-fuel ratio.

5. The air-fuel ratio control apparatus according to claim 1, wherein the reference air-fuel ratio is so set as to decrease with respect to a stoichiometric air-fuel ratio of the internal combustion engine as the alcohol concentration increases.

6. The air-fuel ratio control apparatus according to claim 1, wherein the feedforward correction amount acquisition unit sets the feedforward correction amount to a value obtained by subtracting an amount of fuel for making the air-fuel ratio of the internal combustion engine equal to the reference air-fuel ratio from an amount of fuel for making the air-fuel ratio of the internal combustion engine equal to the target air-fuel ratio.

7. The air-fuel ratio control apparatus according to claim 1, wherein the guard processing execution unit:
sets the first feedback guide value to a value obtained by subtracting the feedforward correction amount from a first total guard value that is an upper limit of a total correction amount for the base fuel injection amount calculated on a basis of the feedback correction amount and the feedforward correction amount; and
sets the second feedback guard value to a value obtained by subtracting the feedforward correction amount from a second total guard value that is a lower limit of the total correction amount.

8. An air-fuel ratio control method for an internal combustion engine including an air-fuel ratio sensor that is provided in an exhaust passage of the internal combustion engine, and that outputs an air-fuel ratio of gas in the exhaust passage; an alcohol concentration sensor that detects an alcohol concentration as a concentration of alcohol components contained in fuel; and a fuel injection device that injects fuel in accordance with a command to inject fuel in a command fuel injection amount, comprising:
determining a base fuel injection amount on a basis of an amount of air taken into a combustion chamber of the internal combustion engine in an intake stroke and a reference air-fuel ratio;
determining a target air-fuel ratio of the internal combustion engine on a basis of an operational state of the internal combustion engine;
determining a feedforward correction amount for correcting the base fuel injection amount on a basis of a deviation of the target air-fuel ratio from the reference air-fuel ratio;
determining a feedback correction amount for correcting the base fuel injection amount on a basis of an output value of the air-fuel ratio sensor;
executing a guard processing for limiting the feedback correction amount to a first feedback guard value if the feedback correction amount exceeds the first feedback guard value and limiting the feedback correction amount to a second feedback guard value if the feedback correction amount drops below the second feedback guard value;
calculating the command fuel injection amount by correcting the base fuel injection amount on a basis of the feedforward correction amount and the feedback correction amount subjected to the guard processing; and
controlling an air-fuel ratio of a mixture supplied to the combustion chamber such that the air-fuel ratio of the mixture coincides with the target air-fuel ratio by issuing to the fuel injection device a command to inject fuel in the command fuel injection amount, wherein
the first feedback guard value and the second feedback guard value are set on a basis of the alcohol concentration and the feedforward correction amount.
